(19) United States
(12) Patent Application Publication
(10) Pub. No.: US 2006/0282432 A1
(43) Pub. Date: Dec. 14, 2006

(54) Sales diagnostics reporting system

(76) Inventors: Douglas J. Cassidy, Lake Forest, IL (US); John W. Hart, Kenilworth, IL (US); Michael E. Pinkowski, Johnsburg, IL (US); Andrew D. Goodfellow, Mundelein, IL (US)

Correspondence Address: Paul E. Schaafsma;NovusIP, LLC, Suite 221, 521 West Superior Street, Chicago, IL, 60610, US

(21) Appl. No.: 11/150,052

(22) Filed: Jun. 10, 2005

(51) Int. Cl. G06F 17/30

(52) U.S. Cl. 707/7

(57) ABSTRACT

In accordance with the principles of the present invention, an automated system for analyzing customer trends is provided. Clients can upload data into the system over a wide area network such as the Internet, preferably using the client's spreadsheet. Reports are created in accordance with the individual customer data. The reports include a quantity of accounts for categories of customer sales characteristics is displayed in the form of number of accounts and percentage of total. A quantification of categories of customer sales characteristics is displayed in the form of sales, sales growth, and percentage of sales growth. In addition, a further quantification of categories of customer sales characteristics is displayed in the form of gross profit, gross profit growth, and percentage of gross profit growth. A contribution of the categories of customer sales characteristics is displayed in the form of margin percentage and percentage of total of gross profit. Various statistics about the categories of customer characteristics can be highlighted. Reports are provided over the wide area network to the appropriate level of management for quick analysis. A summary of significant customer trends is provided in the reports. Also, within the reports a link is provided from the summary data to detailed, backup data. Clients are allowed to customize the reports sort data.

### FIELD OF THE INVENTION

The present invention relates to business sales diagnostic systems.

### BACKGROUND OF THE INVENTION

There exists as a tool to assist sales professionals a variety of software tools, both online and stand alone, in a category generically referred to as customer relationship management (CRM) software. For example, Salesforce.com touts itself as the market and technology leader in on-demand CRM. The CRM applications provided by slaesforce.com are provided “to help enterprises of all sizes, industries and geographies meet the complex challenge of sharing and managing information on-demand.” While adequate at sharing and managing customer information, what the existing CRM software does not do is enable clients to analyze customer portfolios at a level of analysis that includes on-going analysis of existing customers in order to assist in identifying opportunities with current customers.

What would therefore be desirable would be a secure, powerful, and easy-to-use sales diagnostic tool designed to enable clients to analyze on-going analysis of existing customer portfolios and identify opportunities with current customers. What would be further desirable would be a tool to assist clients with analyzing customer trends as well as providing access to growth and profitability opportunities. Additionally, what would be desirable would be a tool to provide to clients an account stratification and customer behavior identification that helps maximize growth potential. What would be desirable would be a tool to provide clients a comprehensive analysis of their business and the customers of their business. What would be desirable would be a report of sales activities that is both purposeful and actionable.

### SUMMARY OF TH INVENTION

A system in accordance with the principles of the present invention provides a secure, powerful, and easy-to-use tool designed to enable clients to analyze customer portfolios and identify opportunities with current customers. A system in accordance with the principles of the present invention assists clients with analyzing customer trends as well as provides access to growth and profitability opportunities. A system in accordance with the principles of the present invention provides to clients an account stratification and customer behavior identification that helps maximize growth potential. A system in accordance with the principles of the present invention provides to clients a comprehensive analysis of their business and the customers of their business. A system in accordance with the principles of the present invention provides a report of sales activities that is both purposeful and actionable.

In accordance with the principles of the present invention, an automated system for analyzing customer trends is provided. Clients can upload data into the system over a wide area network such as the Internet, preferably using the client's spreadsheet. Reports are created in accordance with the individual customer data. The reports include a quantity of accounts for categories of customer sales characteristics is displayed in the form of number of accounts and percentage of total. A quantification of categories of customer sales characteristics is displayed in the form of sales, sales growth, and percentage of sales growth. In addition, a further quantification of categories of customer sales characteristics is displayed in the form of gross profit, gross profit growth, and percentage of gross profit growth. A contribution of the categories of customer sales characteristics is displayed in the form of margin percentage and percentage of total of gross profit. Various statistics about the categories of customer characteristics can be highlighted. Reports are provided over the wide area network to the appropriate level of management for quick analysis. A summary of significant customer trends is provided in the reports. Also, within the reports a link is provided from the summary data to detailed, backup data. Clients are allowed to customize the reports sort data.

### BRIEF DESCRIPTION OF THE DRAWINGS

FIG. 1 shows a non-limiting example of a hardware infrastructure that can be used to run the system of the present invention.

FIG. 2 shows a login screen in accordance with the principles of the present invention.

FIG. 3 shows a homepage screen in accordance with the principles of the present invention.

FIG. 4 shows a user profile screen in accordance with the principles of the present invention.

FIG. 5 shows a reports screen in accordance with the principles of the present invention.

FIG. 6 shows a data management screen in accordance with the principles of the present invention.

FIG. 7 shows an upload data screen in accordance with the principles of the present invention.

FIG. 8 shows an administration screen in accordance with the principles of the present invention.

FIG. 9 shows a customer stratification report screen in accordance with the principles of the present invention.

FIG. 10 shows a customer stratification report summary page in accordance with the principles of the present invention.

FIG. 11 shows a profit contribution customization screen in accordance with the principles of the present invention.

FIG. 12 shows a customer criteria customization screen in accordance with the principles of the present invention.

FIG. 13 shows a key financial indicator customization screen in accordance with the principles of the present invention.

FIG. 14 shows a level of detail customization screen in accordance with the principles of the present invention.

FIG. 15 shows a sort column customization screen in accordance with the principles of the present invention.

FIG. 16 shows an example of a customer stratification report in accordance with the principles of the present invention.

FIG. 17 shows a customer growth and decline report screen in accordance with the principles of the present invention.

FIG. 18 shows customer growth and decline report summary screen in accordance with the principles of the present invention.

FIG. 19 shows a stable customers criteria customization screen in accordance with the principles of the present invention.

FIG. 20 shows an example of a customer growth and decline report

FIG. 21 shows a detailed stratification report screen in accordance with the principles of the present invention.

FIG. 22 shows a detailed stratification report summary page in accordance with the principles of the present invention.

FIG. 23 shows a customer category and stable customer customization screen in accordance with the principles of the present invention.

FIG. 24 shows an example of a detailed stratification report in accordance with the principles of the present invention.

FIG. 25 shows an industry segmentation report screen in accordance with the principles of the present invention.

FIG. 26 shows an industry segmentation report summary page in accordance with the principles of the present invention.

FIG. 27 shows an example of an industry segmentation report in accordance with the principles of the present invention.

FIG. 28 shows a region summary report screen in accordance with the principles of the present invention.

FIG. 29 shows an industry segmentation report summary page in accordance with the principles of the present invention.

FIG. 30 shows an example of a Region Summary report page in accordance with the principles of the present invention.

FIG. 31 shows a sales representative/territory summary report screen in accordance with the principles of the present invention.

FIG. 32 shows a sales representative/territory summary report summary page in accordance with the principles of the present invention.

FIG. 33 shows an example of a sales representative/territory summary report in accordance with the principles of the present invention.

FIG. 34 shows a sales representative/territory detail summary report screen in accordance with the principles of the present invention.

FIG. 35 shows a sales representative/territory detail report in accordance with the principles of the present invention.

FIG. 36 shows an example of a manager's report in accordance with the principles of the present invention.

FIG. 37 shows an example of a sales representative's monthly plan report in accordance with the principles of the present invention.

FIG. 38 shows an example of a sales representative's weekly activity report in accordance with the principles of the present invention.

### DETAILED DESCRIPTION OF THE INVENTION

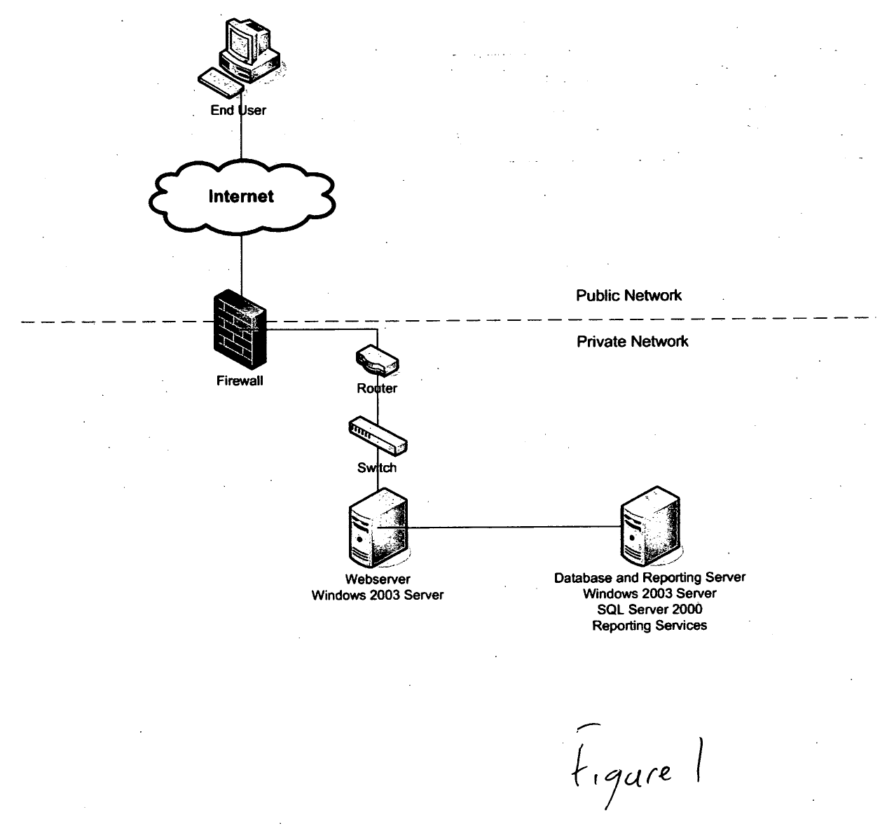

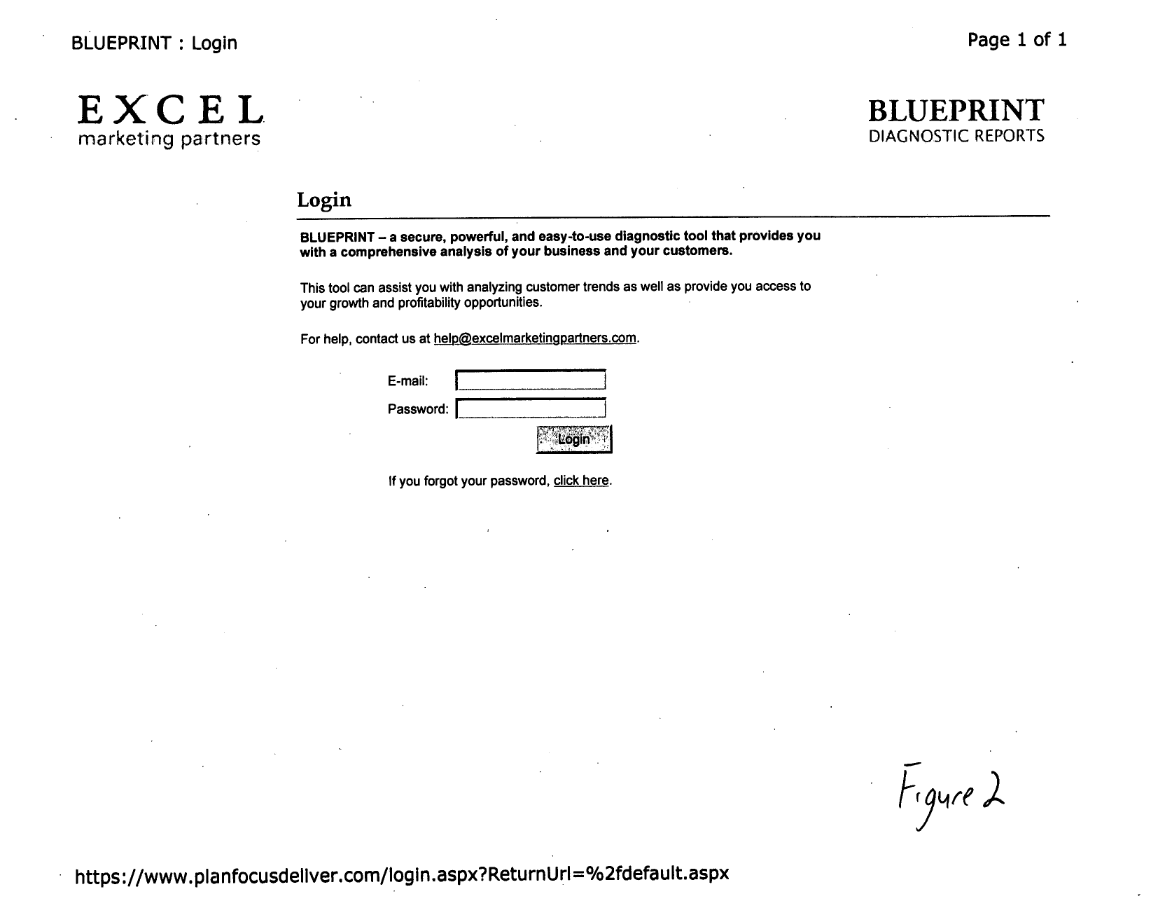

In accordance with one exemplary embodiment of the present invention, a business accesses a sales analysis and diagnostic system in accordance with the principles of the present invention via the worldwide web using an Internet browser. A non-limiting example of a hardware infrastructure that can be used to run the system of the present invention is seen in FIG. 1. The infrastructure should include but not be limited to: Internet connectivity; network infrastructure with bi-directional bandwidth equal to or greater than 1.54 Mbit/sec; an operating system such as a MS Windows 2000 Server or 2003 Server available from Microsoft Corporation, Redmond, Wash.; firewall(s); Microsoft .NET Framework 1.1, Load Balancer (optional if more than one WEB/APP server running the application); appropriate switches and routers; electrical power (backup power); and Network Backup hardware and software. While the exemplary embodiment described herein is enabled on a wide area network, the principles of the present invention apply to other implementations, including but not limited implementation on a local area network, a desktop computer, a personal computer and/or a mainframe computer

The application can run a Secure Sockets Layer (SSL) protocol. The WEB/APP Server can be a 1 GHZ PIII or PIV, or dual processor PIII or XEON at 600 MHZ, with 2 GIG of RAM, 20 GIG Raid level 1, 100 Megabit or 1 GHZ network connection, and DAT 12/24 Backup system. The Database Server can be a Dual Processor XEON 800 or Single Processor 1.8 GHZ PIV with 1 GIG of RAM, ON-Board 18 GIG at Raid level 1, either on-board or external disk array running raid level 3, with 3-36 GIG hard drives,

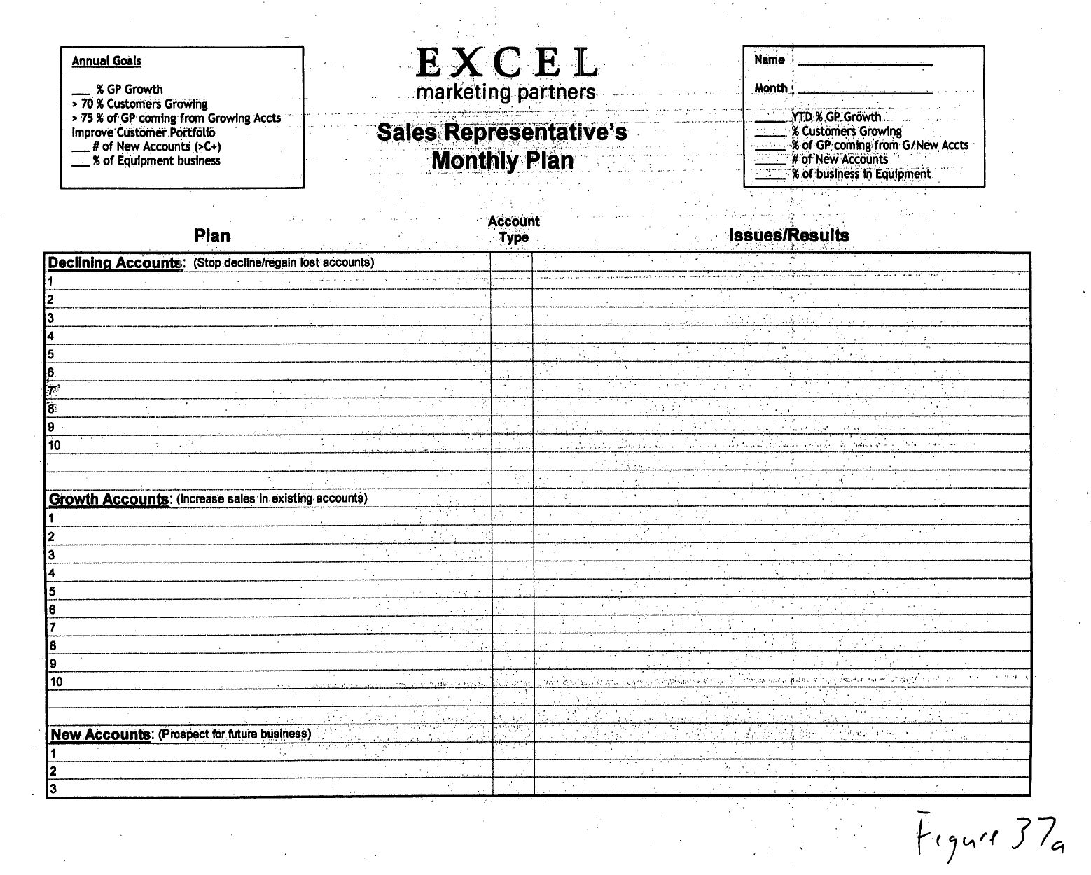

FIG. 36 shows an example of a manager's report in accordance with the principles of the present invention.

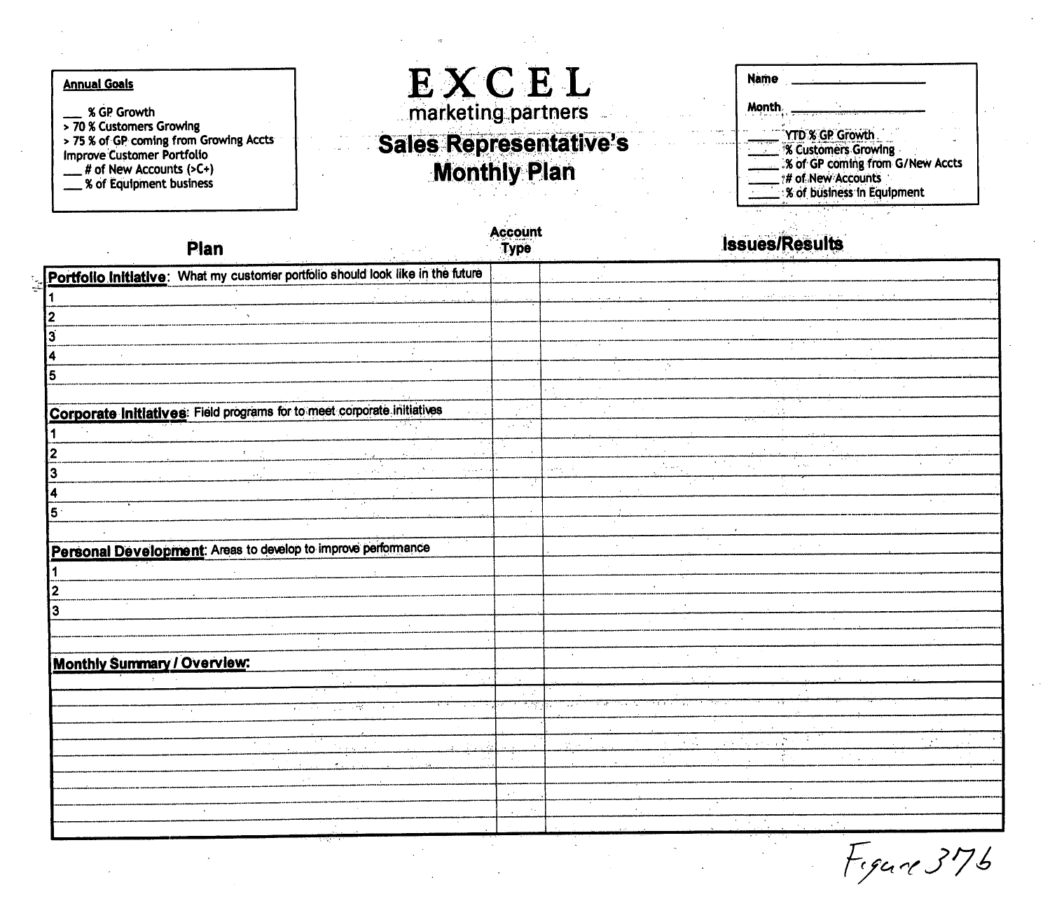

FIG. 37 shows an example of a sales representative's monthly plan report in accordance with the principles of the present invention.

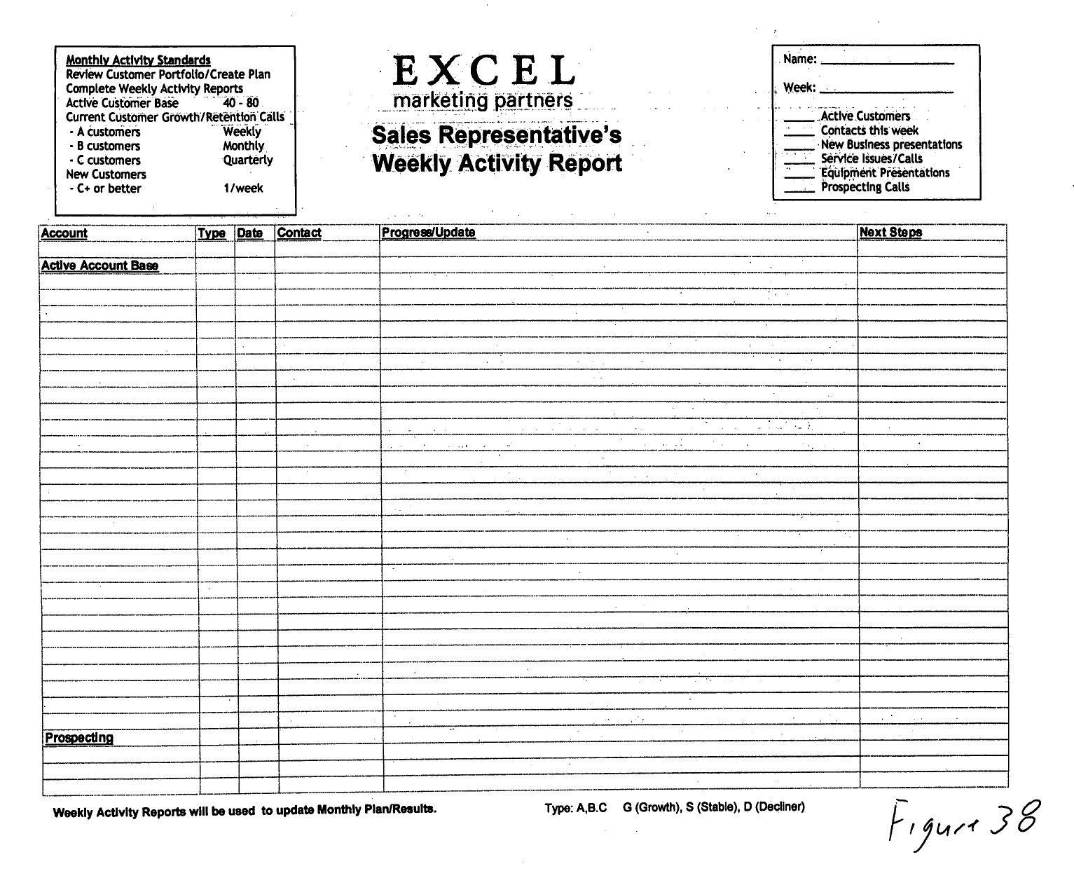

FIG. 38 shows an example of a sales representative's weekly activity report in accordance with the principles of the present invention.

### DETAILED DESCRIPTION OF THE INVENTION

In accordance with one exemplary embodiment of the present invention, a business accesses a sales analysis and diagnostic system in accordance with the principles of the present invention via the worldwide web using an Internet browser. A non-limiting example of a hardware infrastructure that can be used to run the system of the present invention is seen in FIG. 1. The infrastructure should include but not be limited to: Internet connectivity; network infrastructure with bi-directional bandwidth equal to or greater than 1.54 Mbit/sec; an operating system such as a MS Windows 2000 Server or 2003 Server available from Microsoft Corporation, Redmond, Wash.; firewall(s); Microsoft .NET Framework 1.1, Load Balancer (optional if more than one WEB/APP server running the application); appropriate switches and routers; electrical power (backup power); and Network Backup hardware and software. While the exemplary embodiment described herein is enabled on a wide area network, the principles of the present invention apply to other implementations, including but not limited implementation on a local area network, a desktop computer, a personal computer and/or a mainframe computer

The application can run a Secure Sockets Layer (SSL) protocol. The WEB/APP Server can be a 1 GHZ PIII or PIV, or dual processor PIII or XEON at 600 MHZ, with 2 GIG of RAM, 20 GIG Raid level 1, 100 Megabit or 1 GHZ network connection, and DAT 12/24 Backup system. The Database Server can be a Dual Processor XEON 800 or Single Processor 1.8 GHZ PIV with 1 GIG of RAM, ON-Board 18 GIG at Raid level 1, either on-board or external disk array running raid level 3, with 3-36 GIG hard drives, and 100 GIG active backup system, capable of backing up and restoring while the system is active. The system software can be a WEB/APP Server—running Windows 2000, or Windows 2003 Server for dual processor machine; a Database Server—running Windows, or Windows 2003 Server running Microsoft SQL Server 2000 Enterprise Edition for dual processor machine installed with Microsoft Reporting Server and Services.

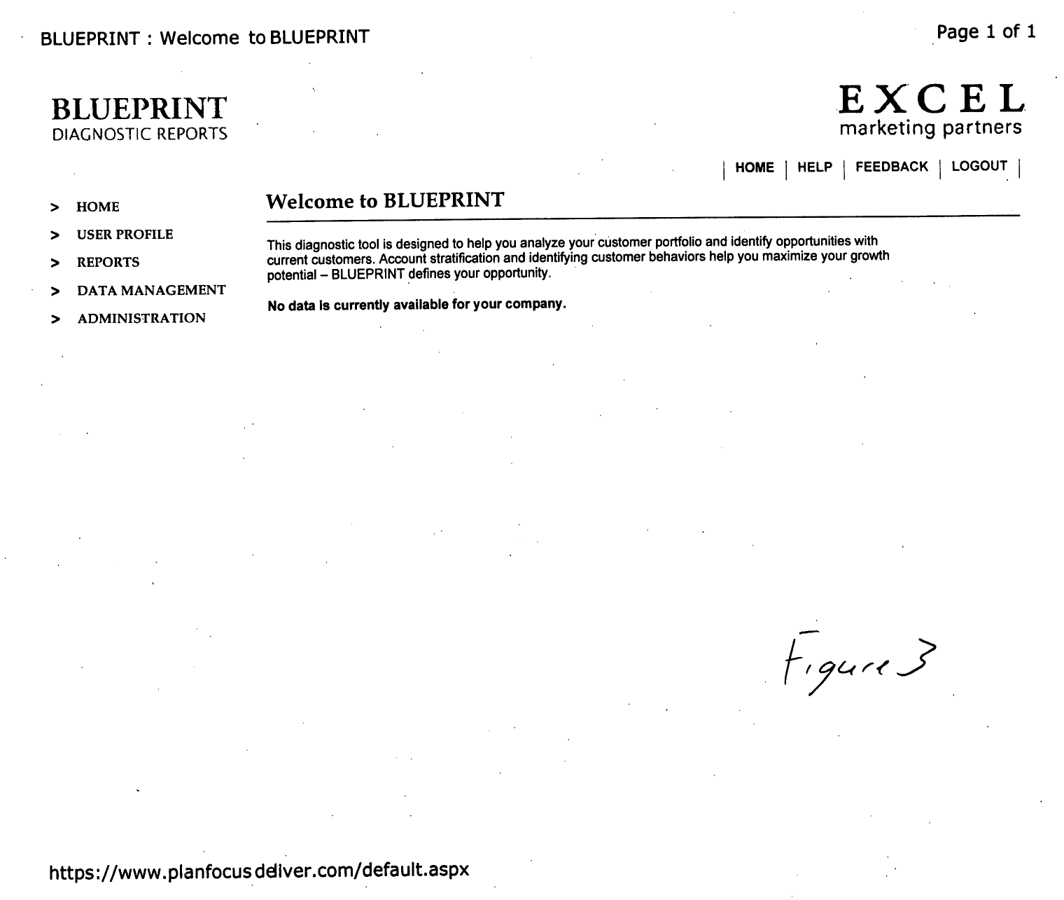

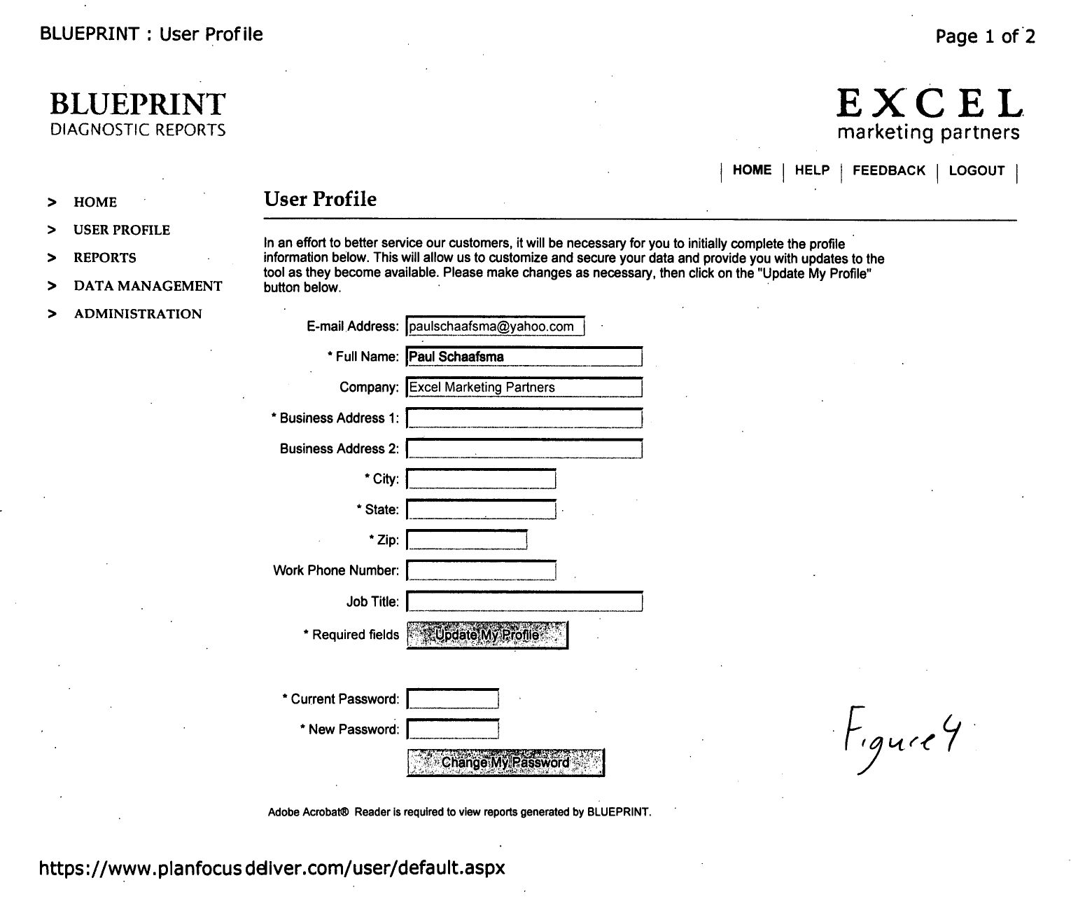

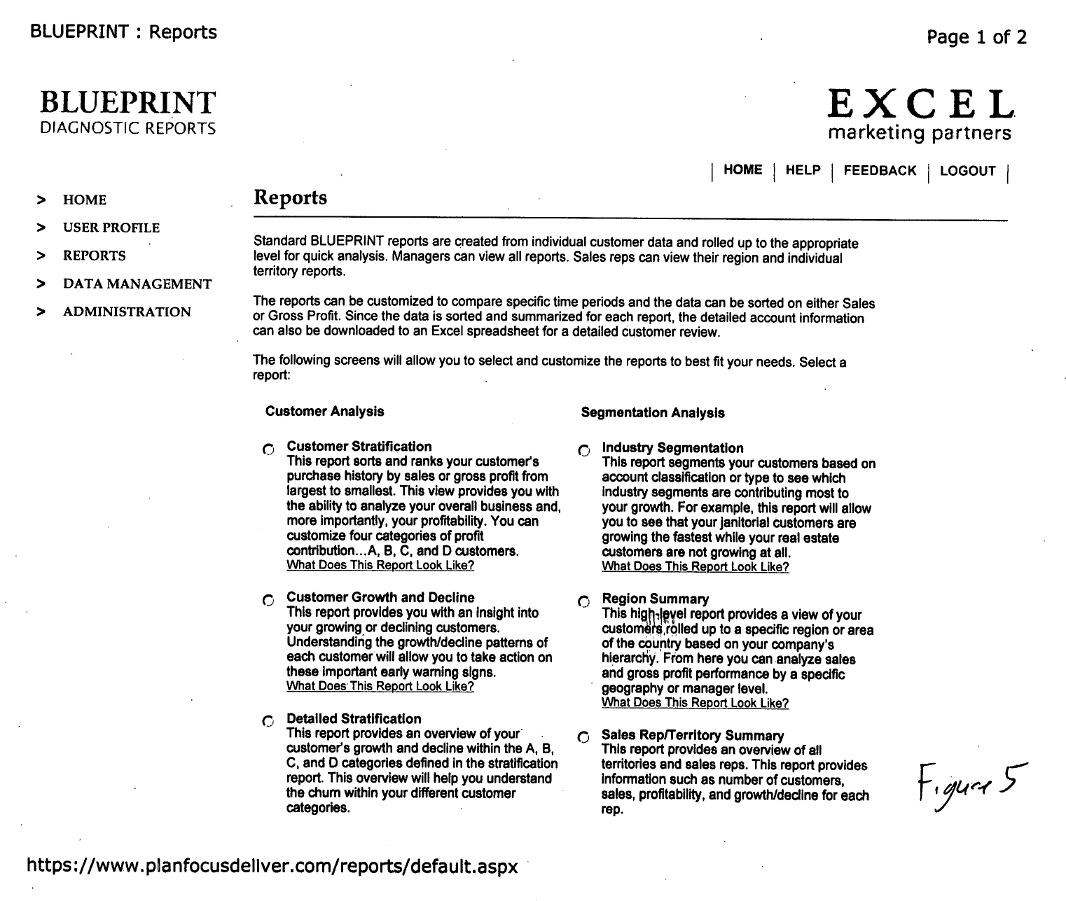

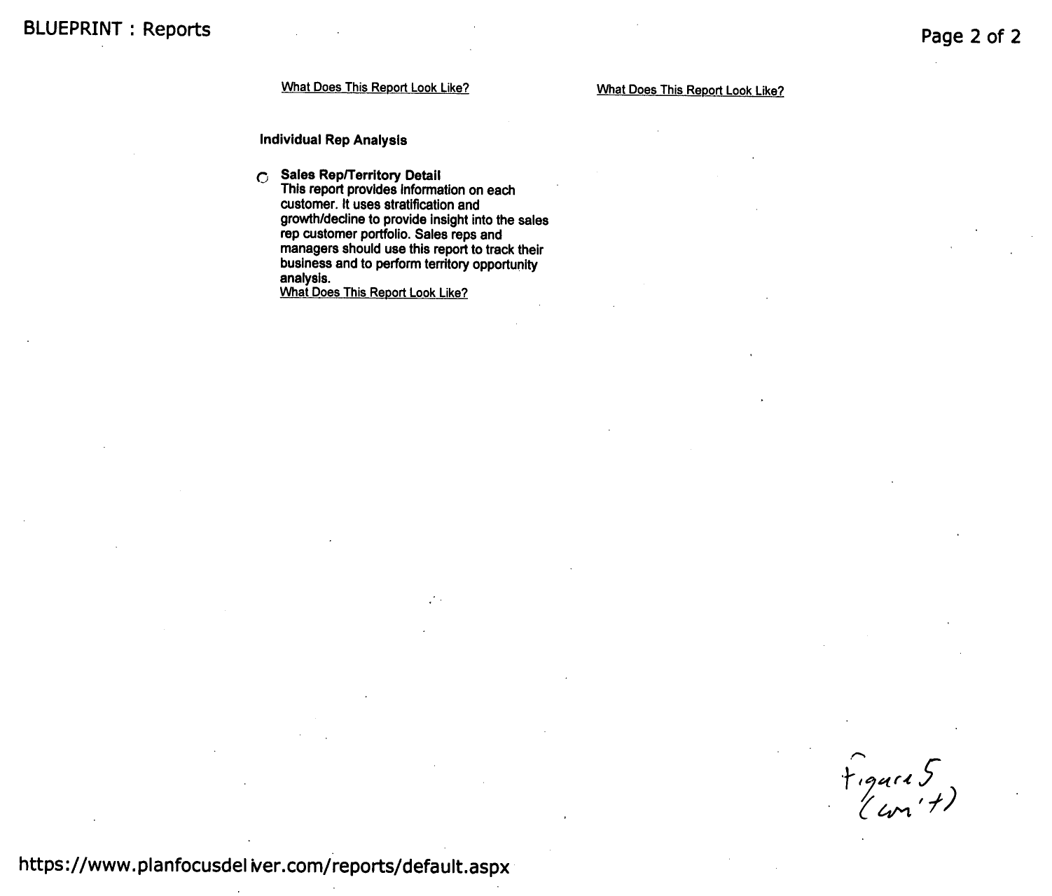

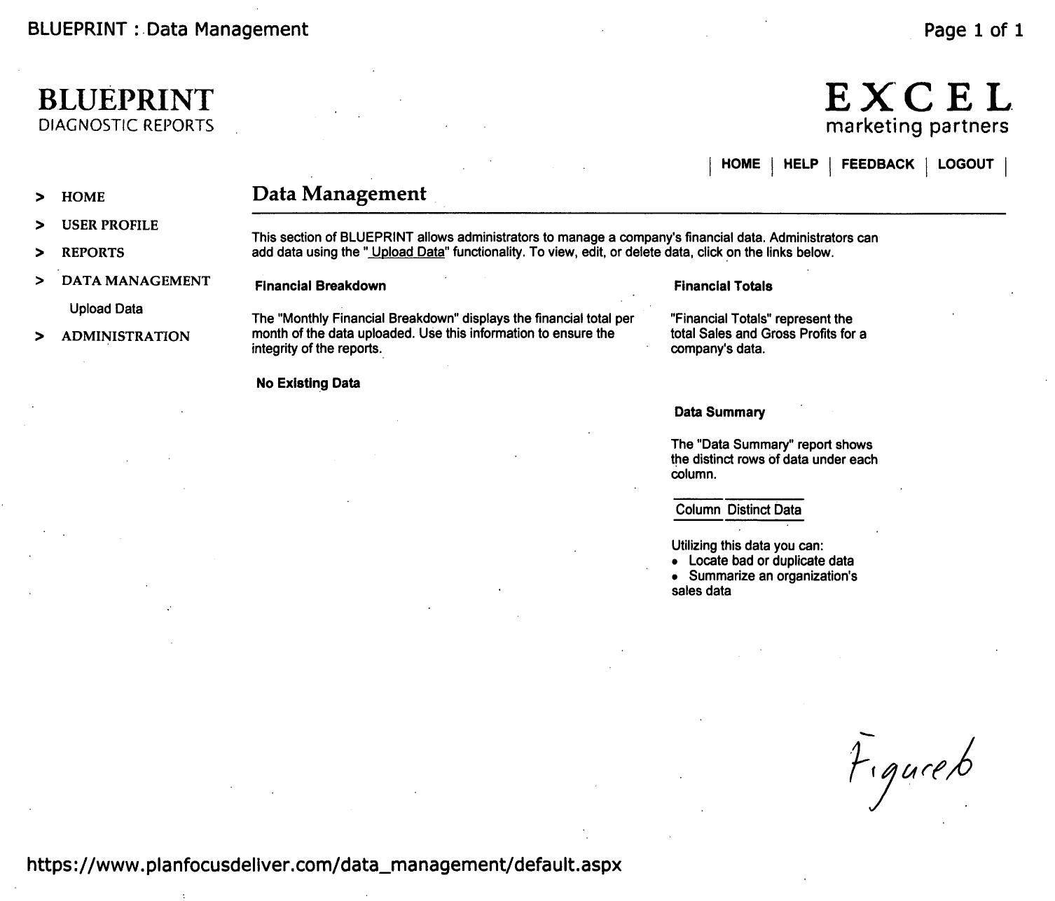

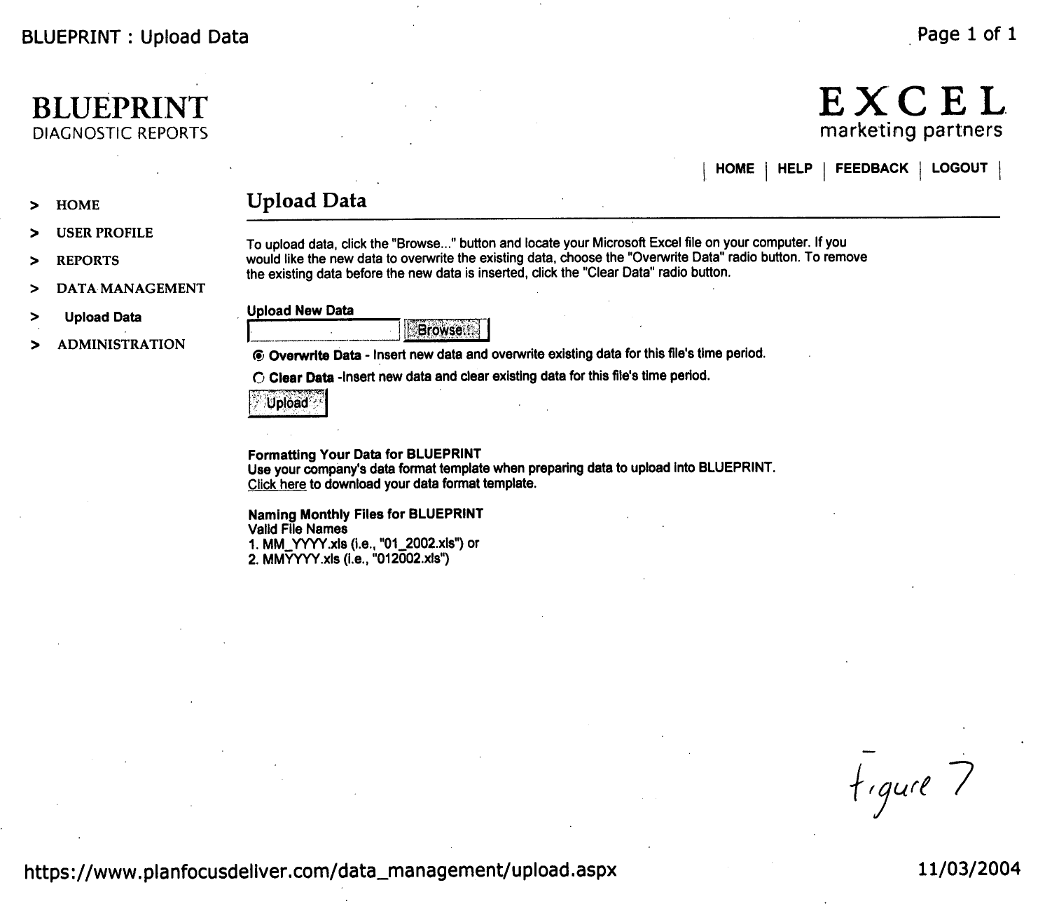

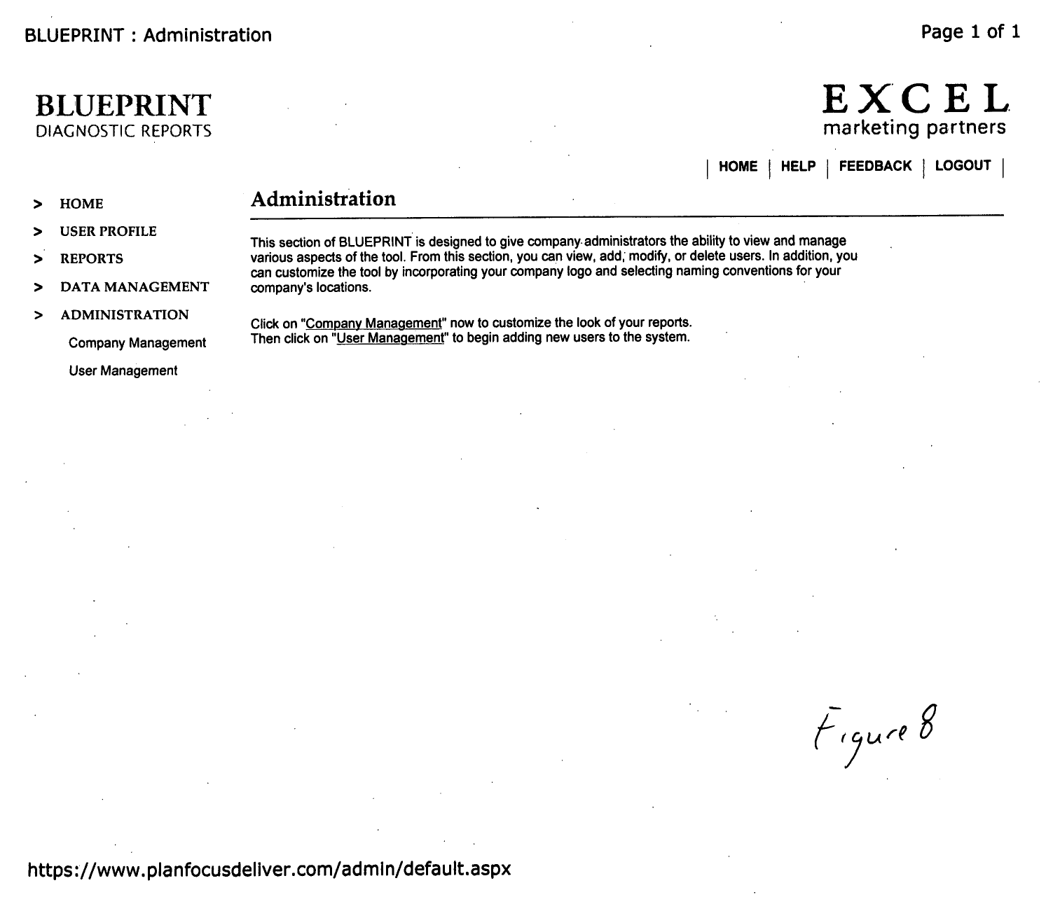

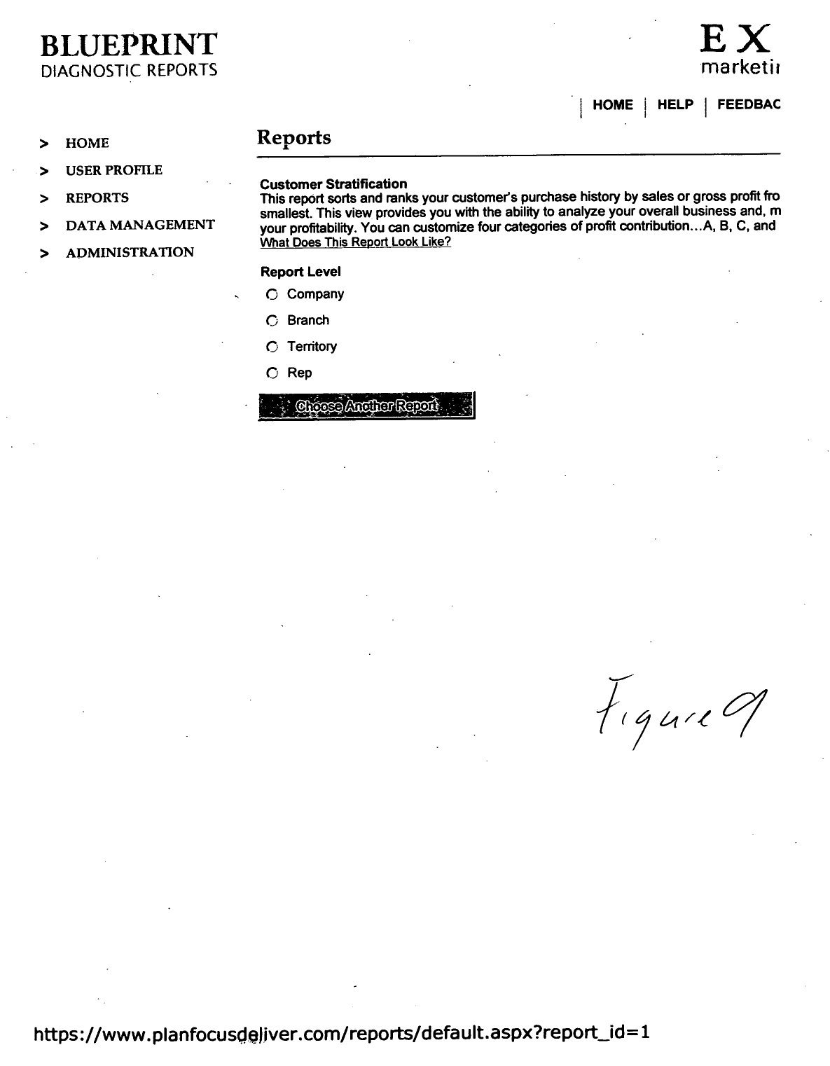

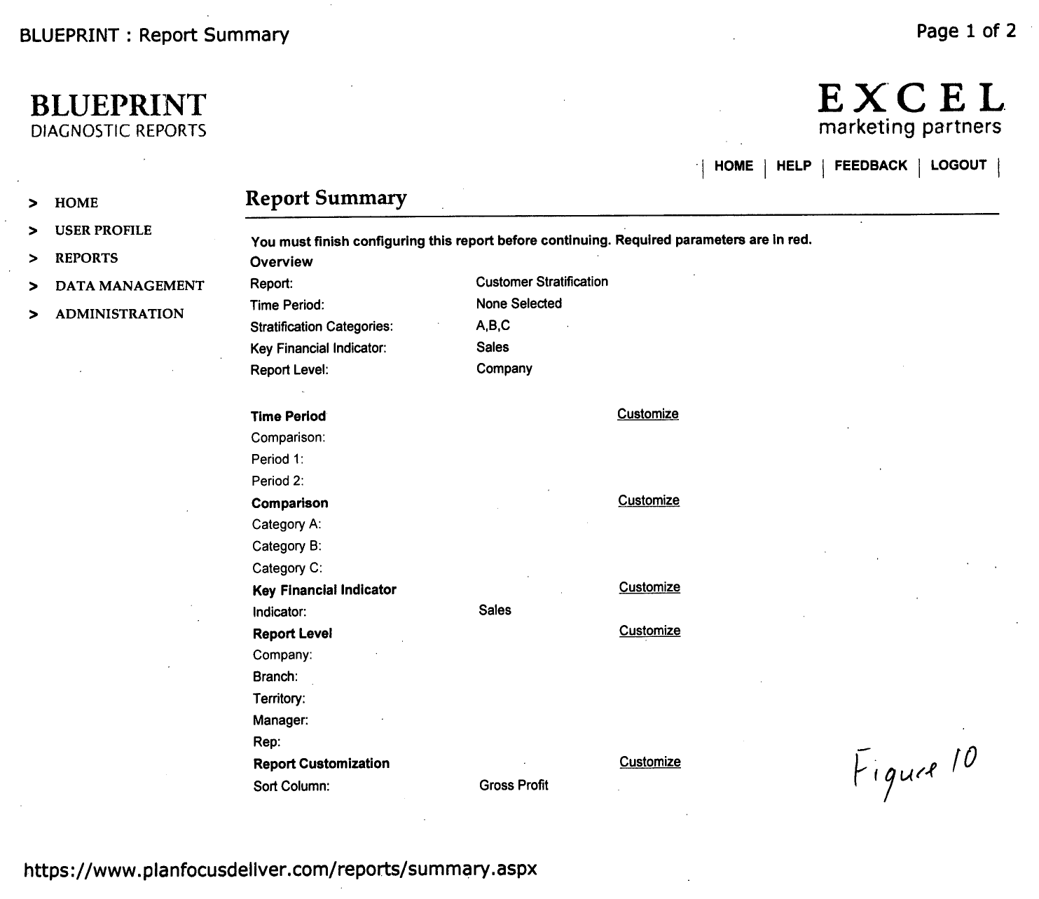

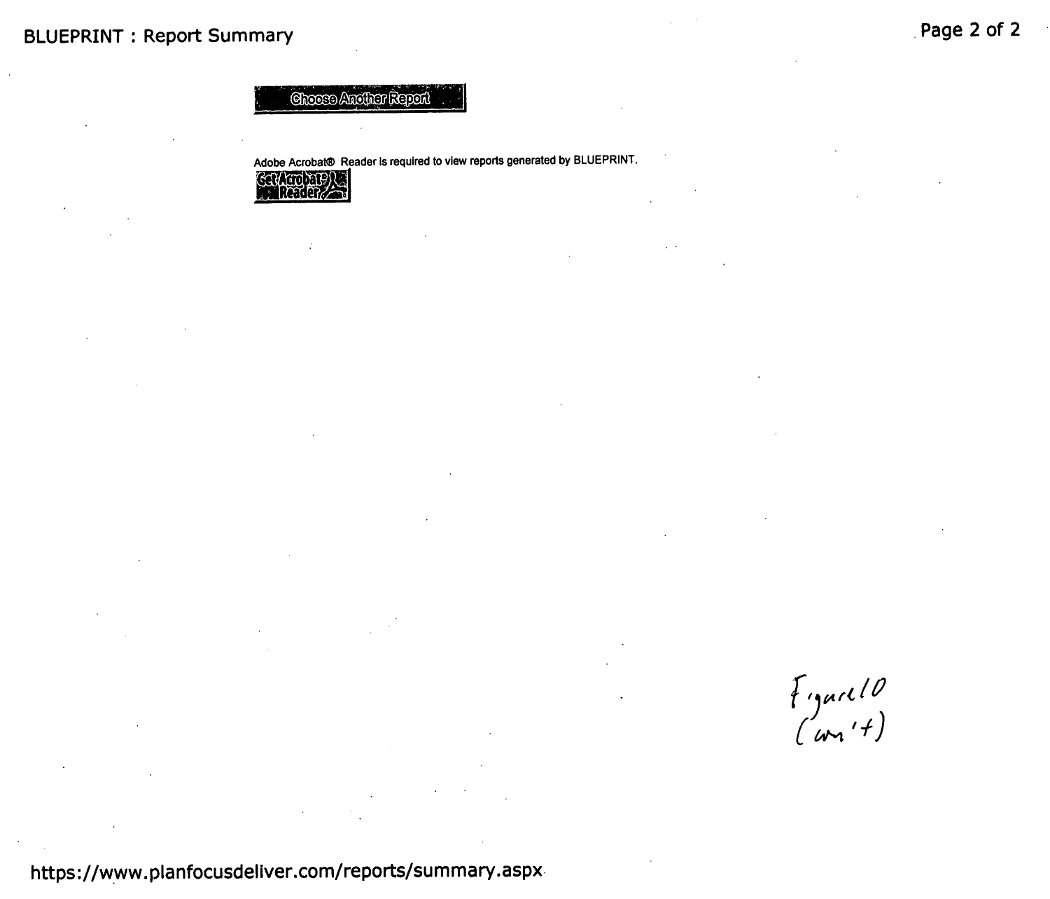

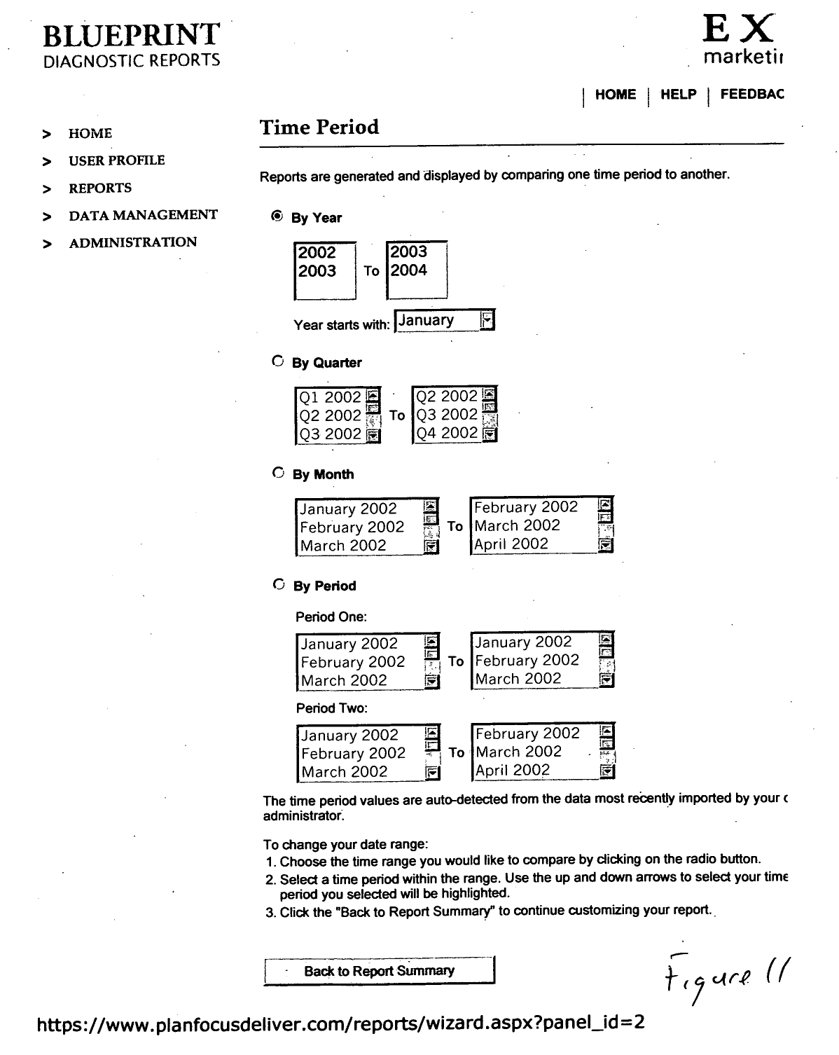

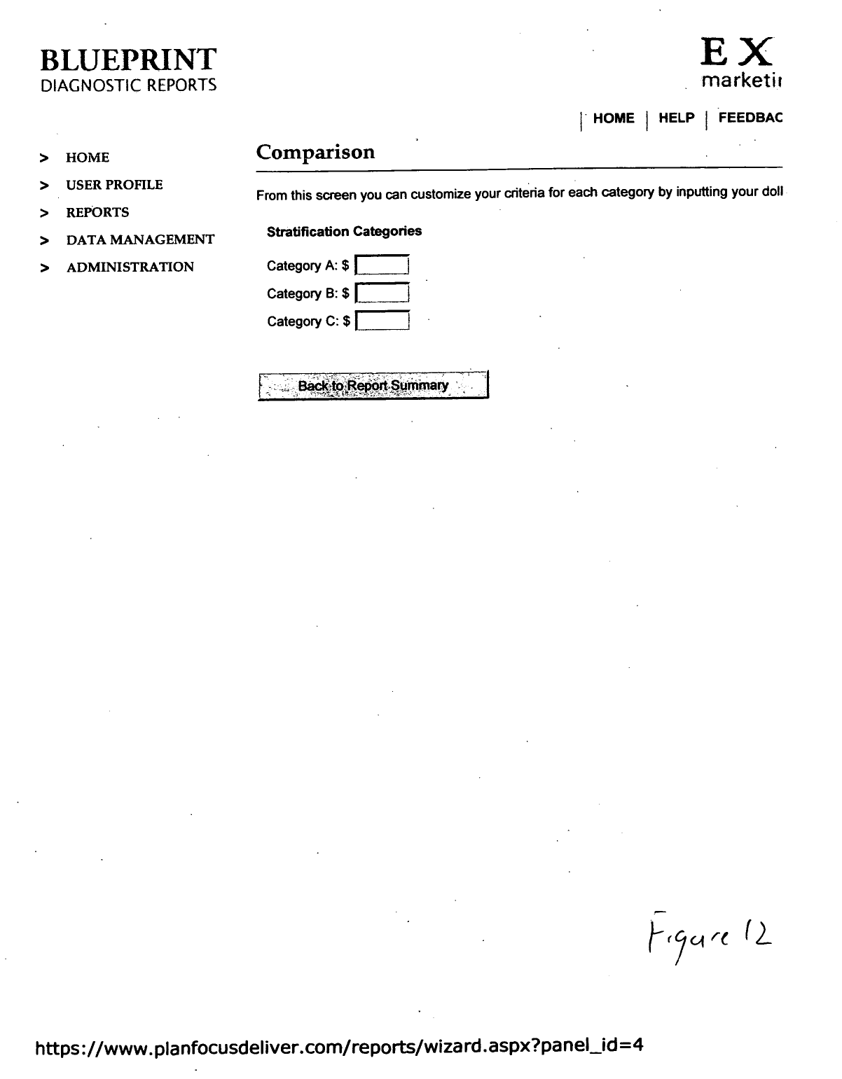

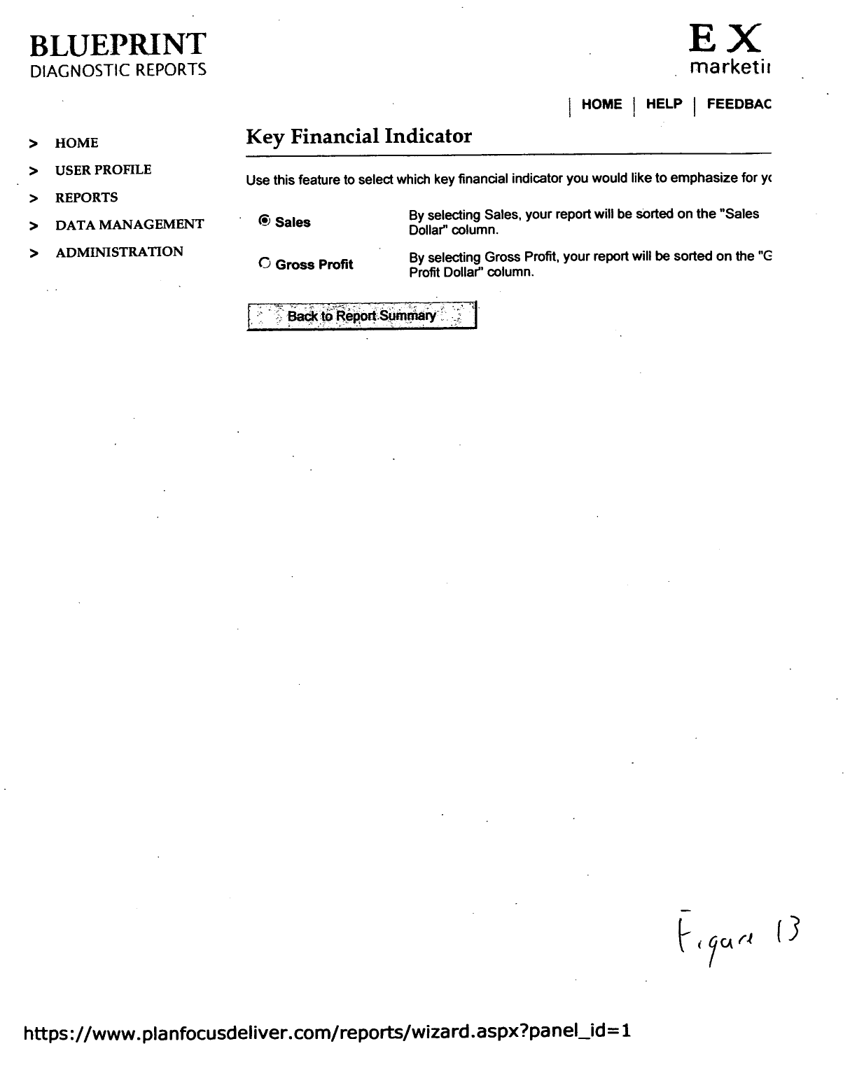

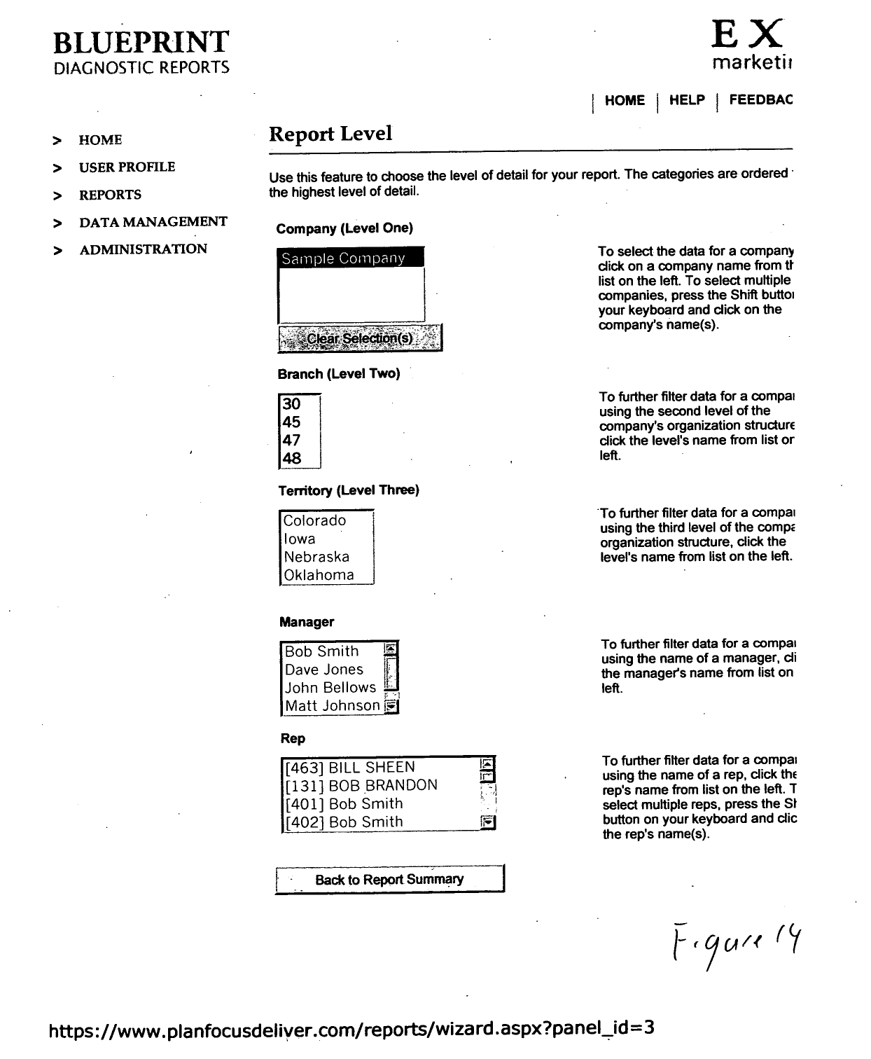

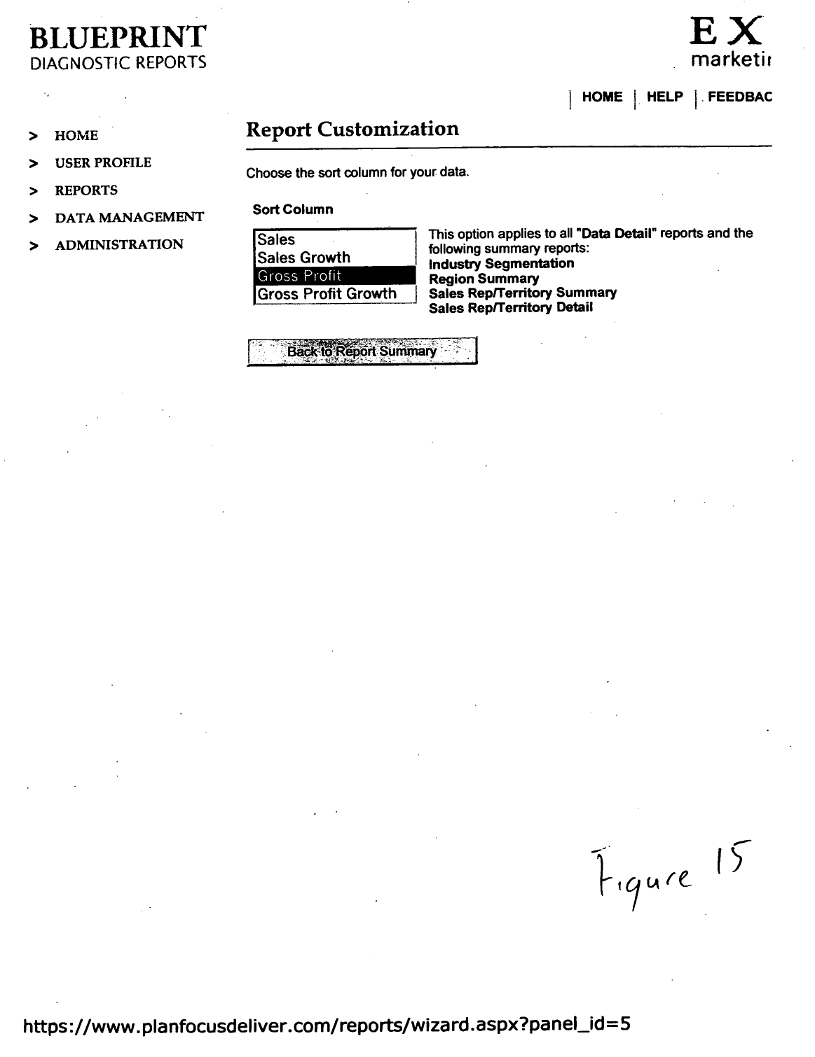

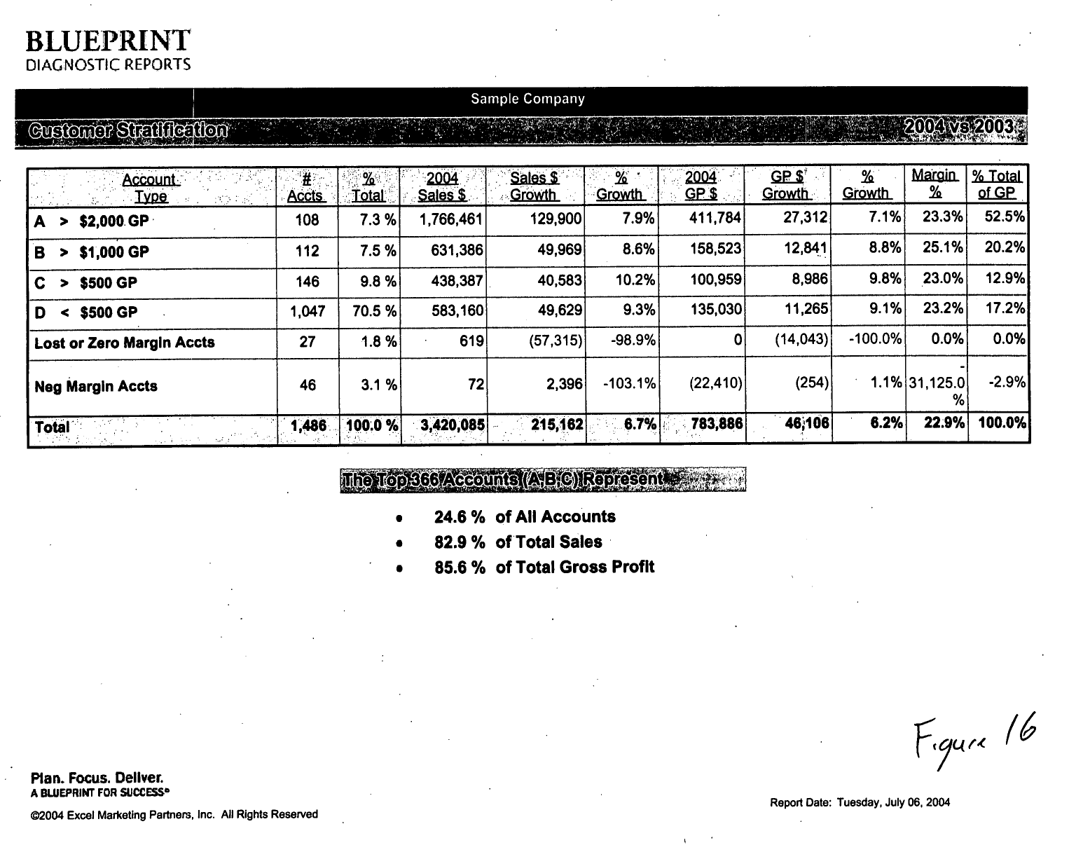

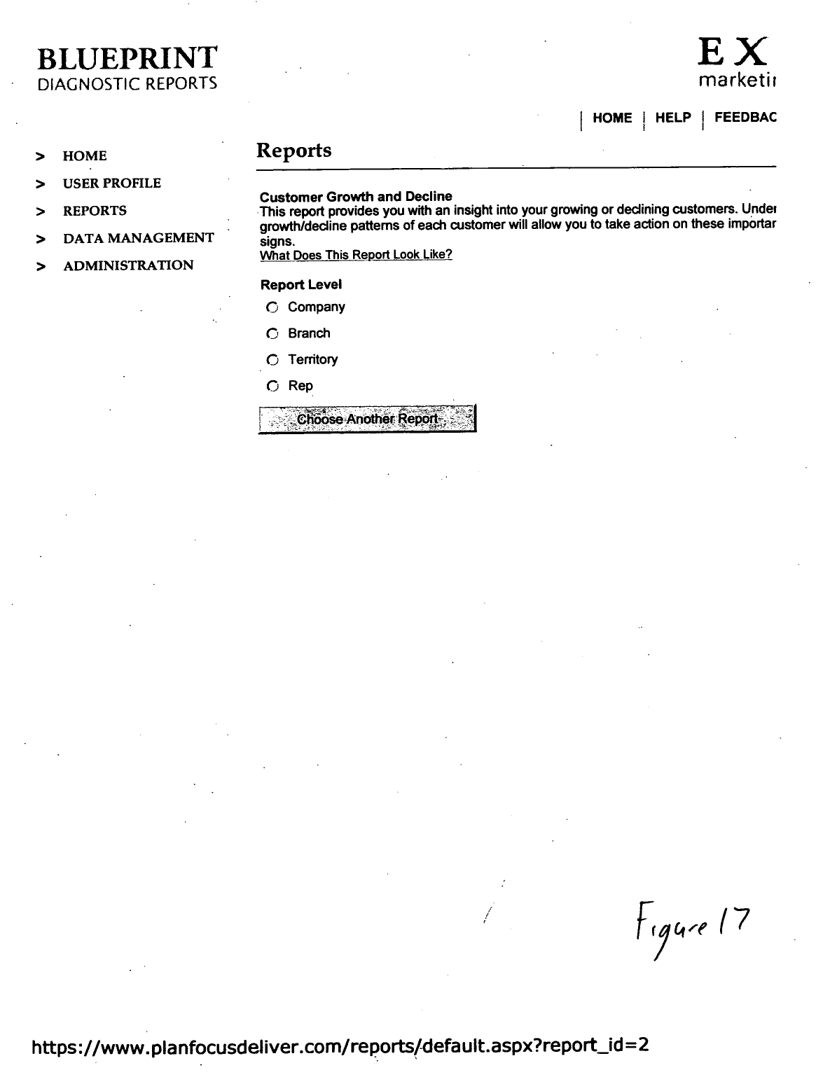

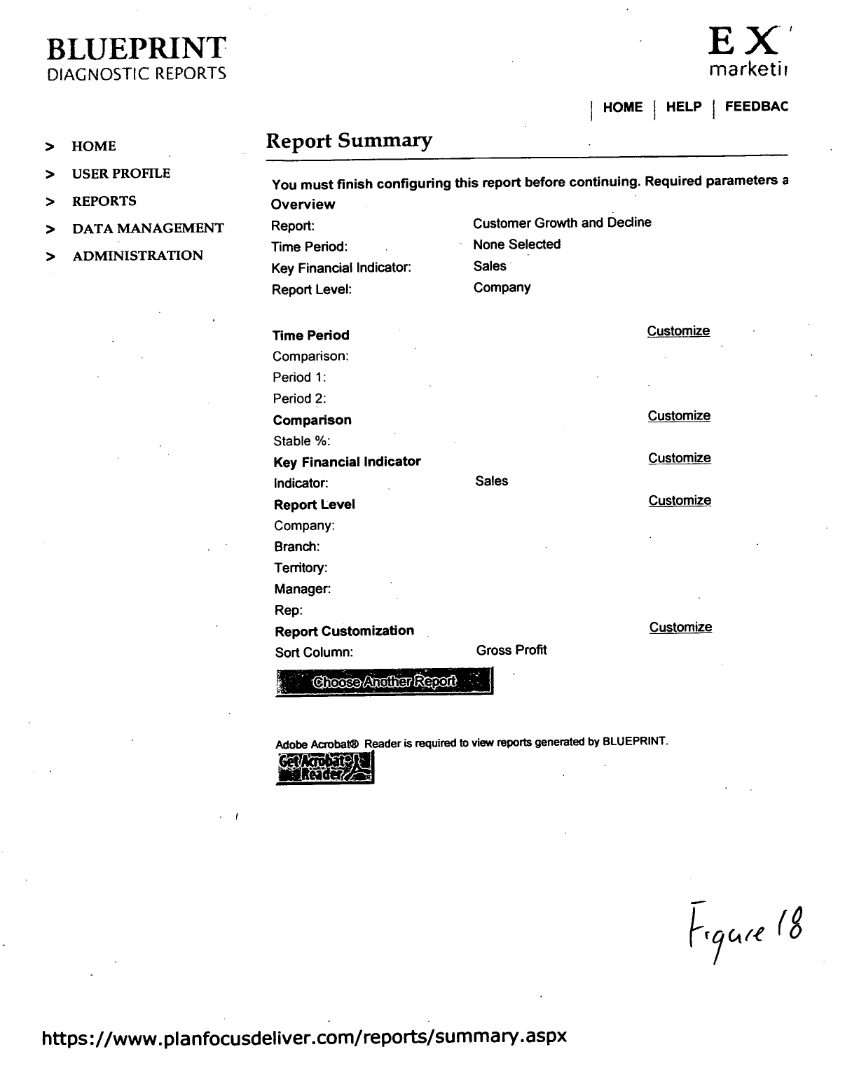

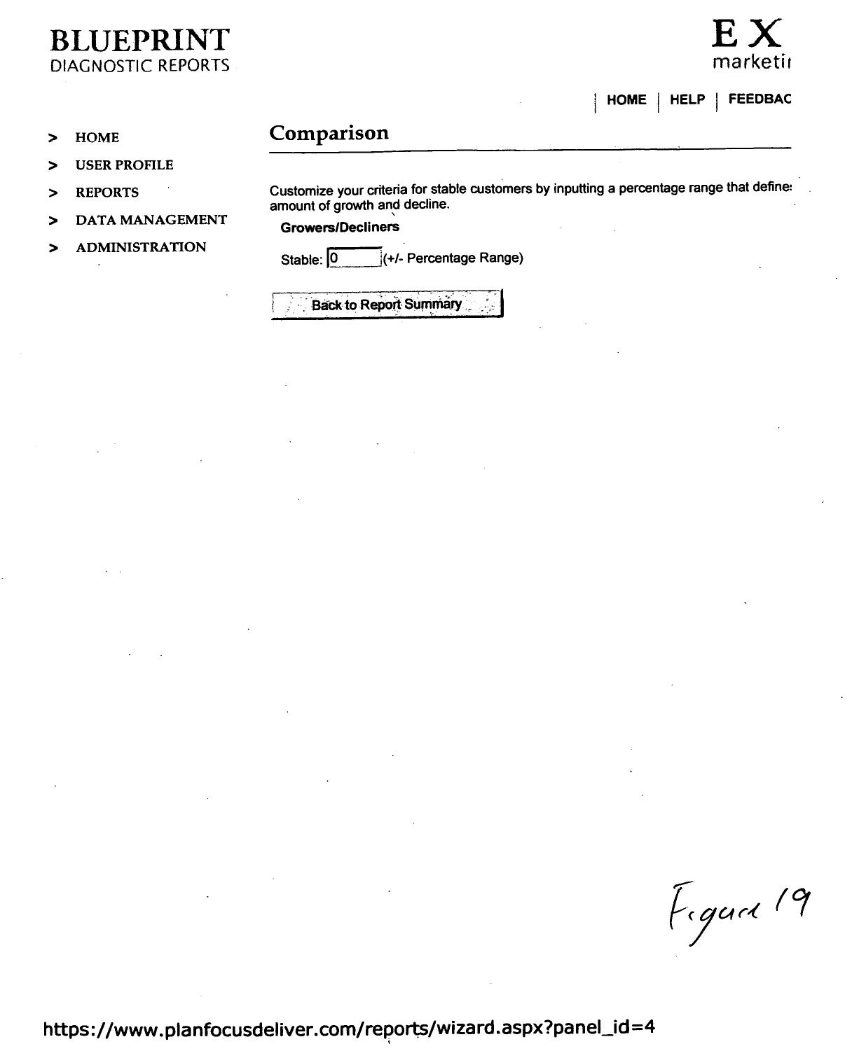

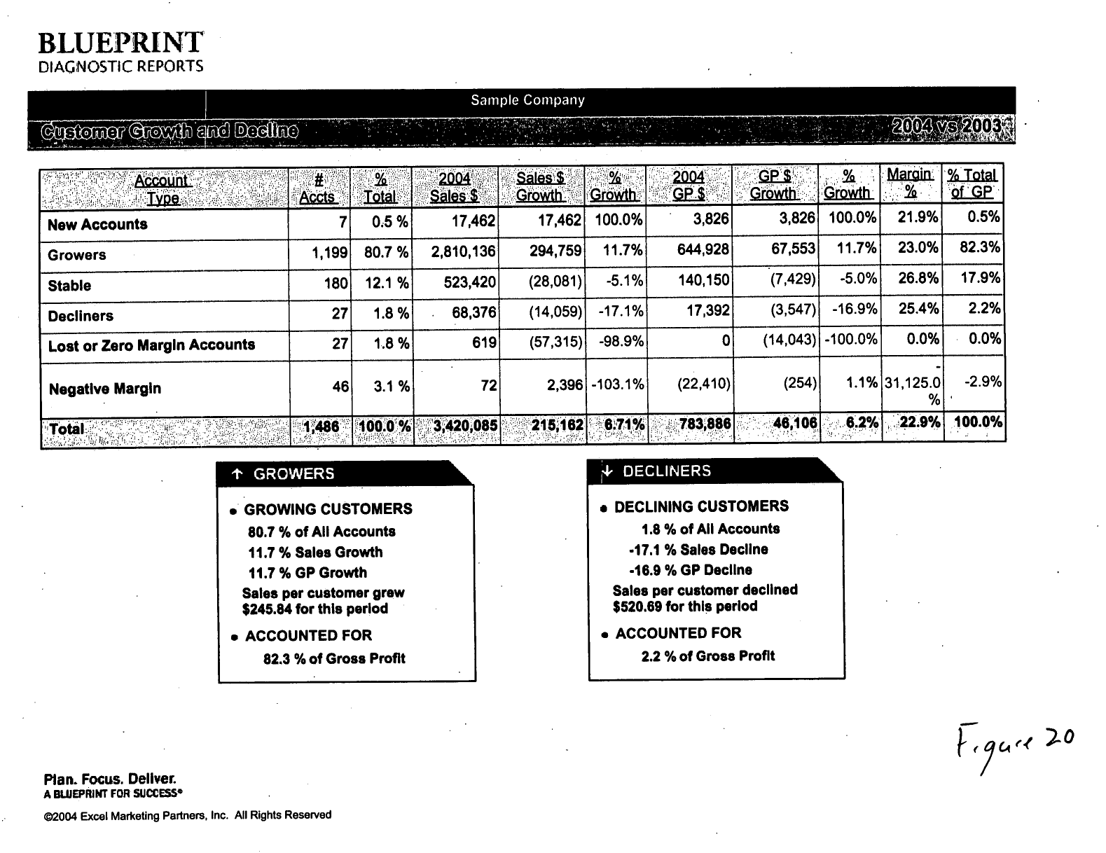

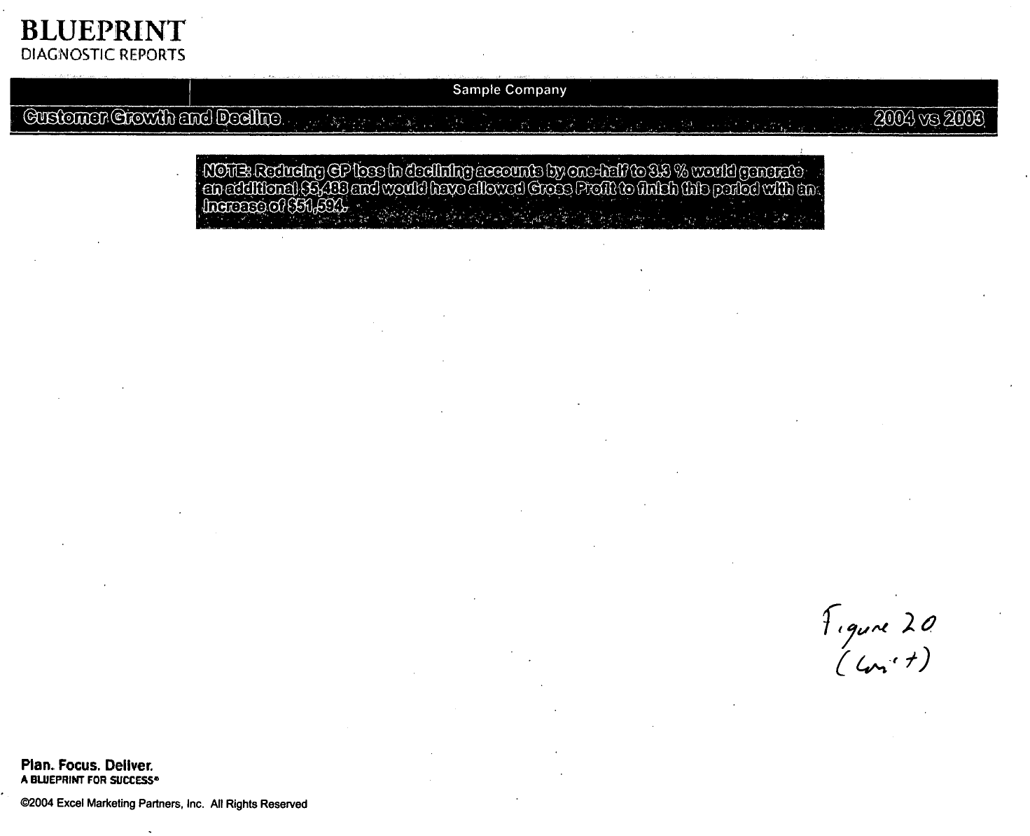

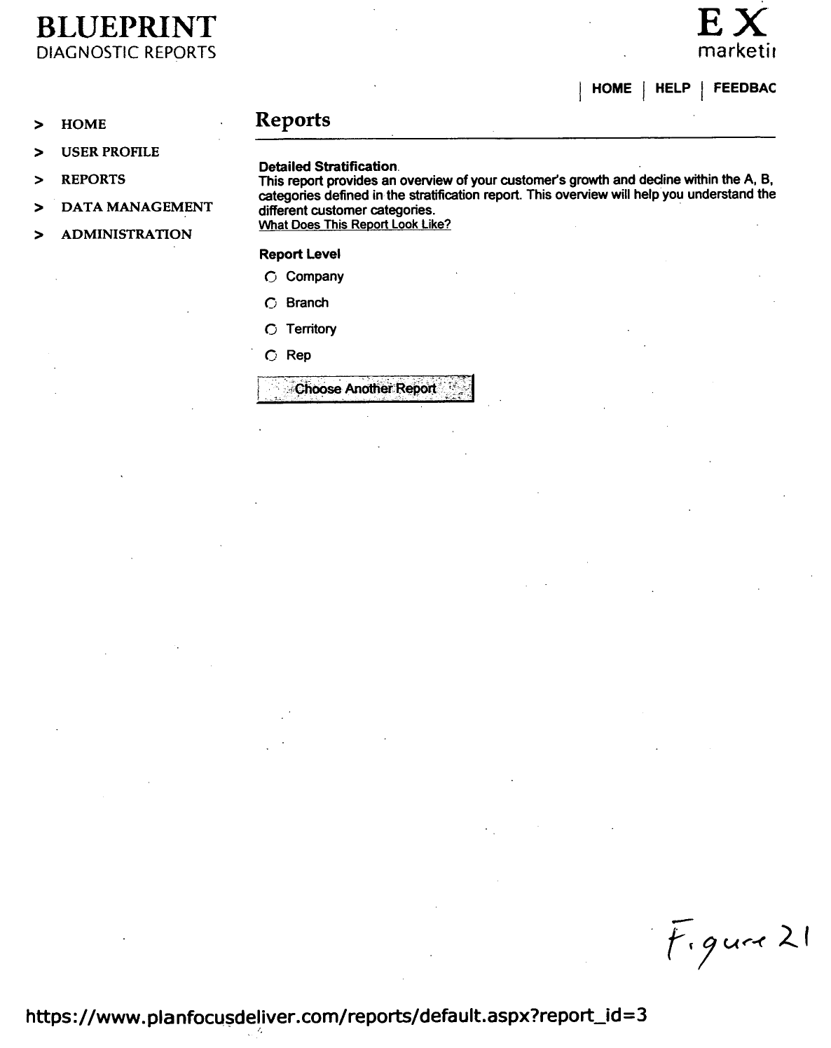

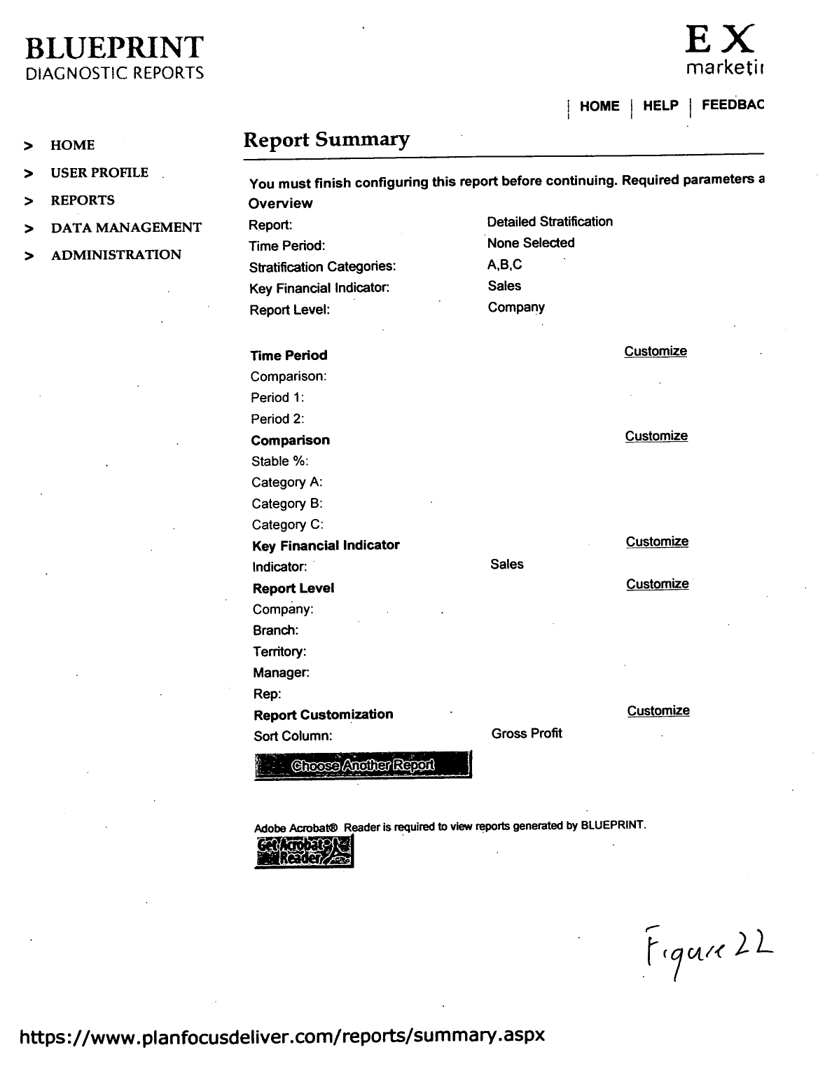

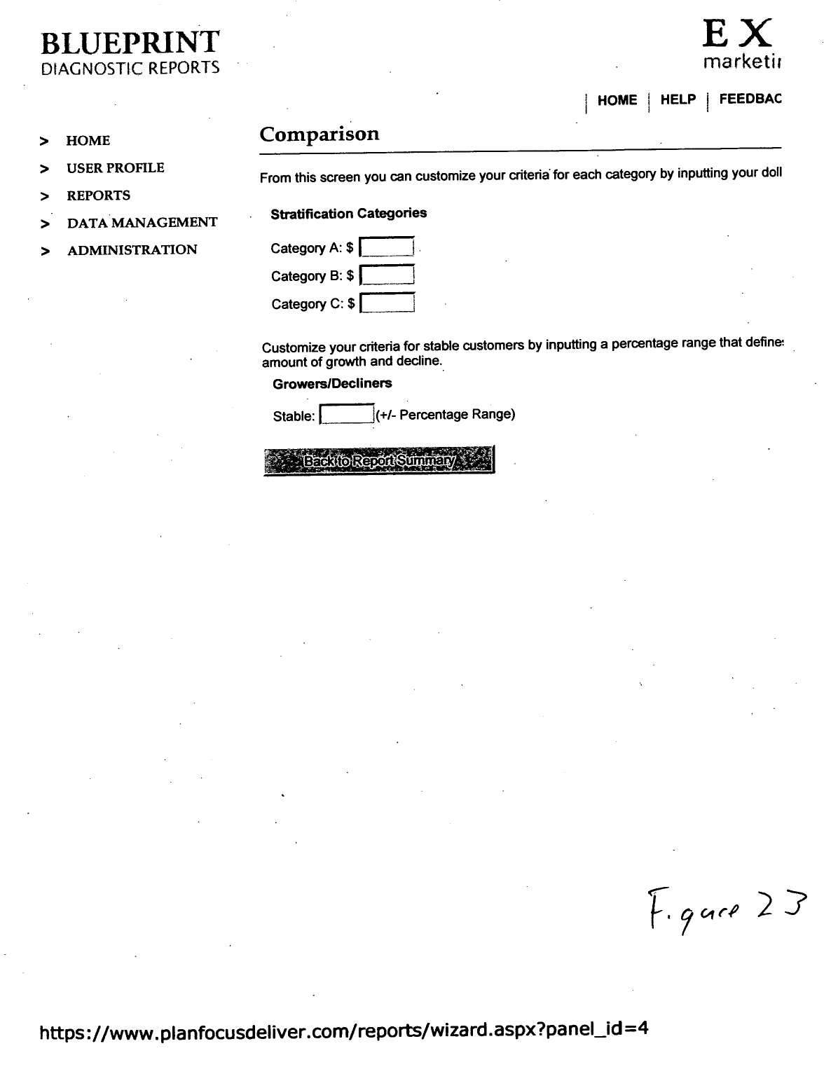

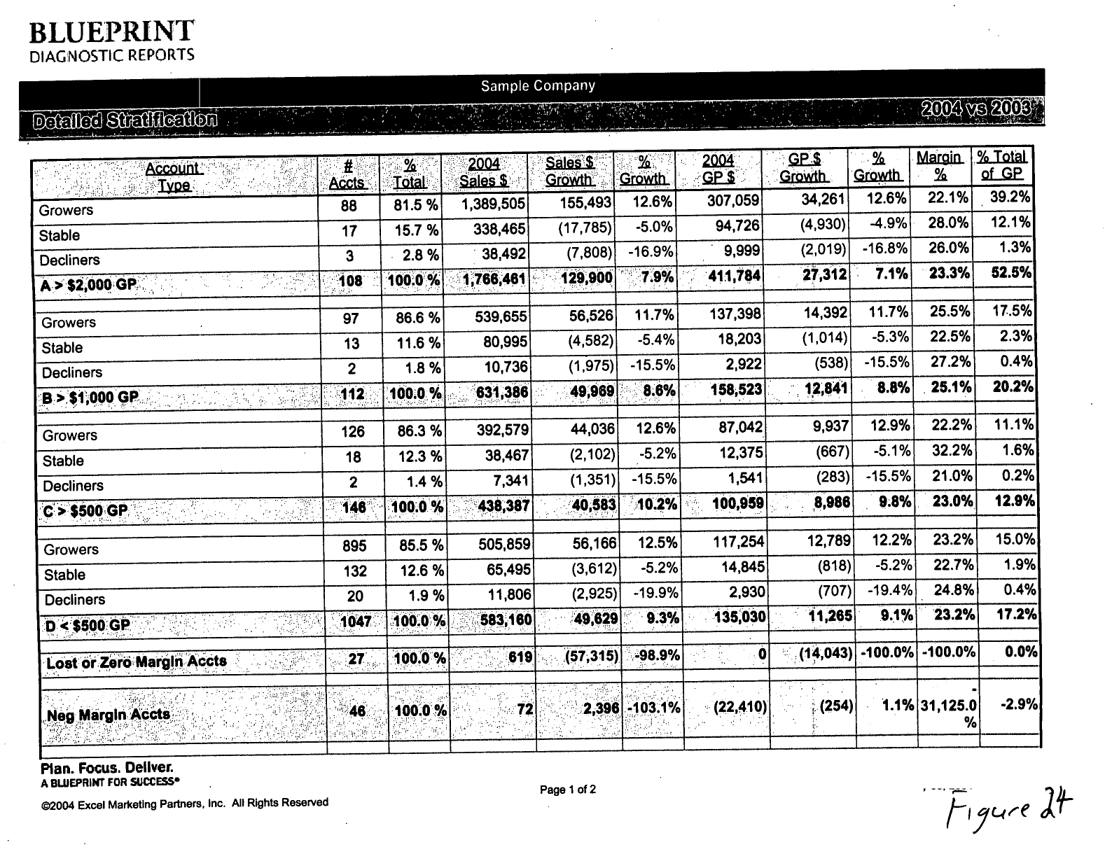

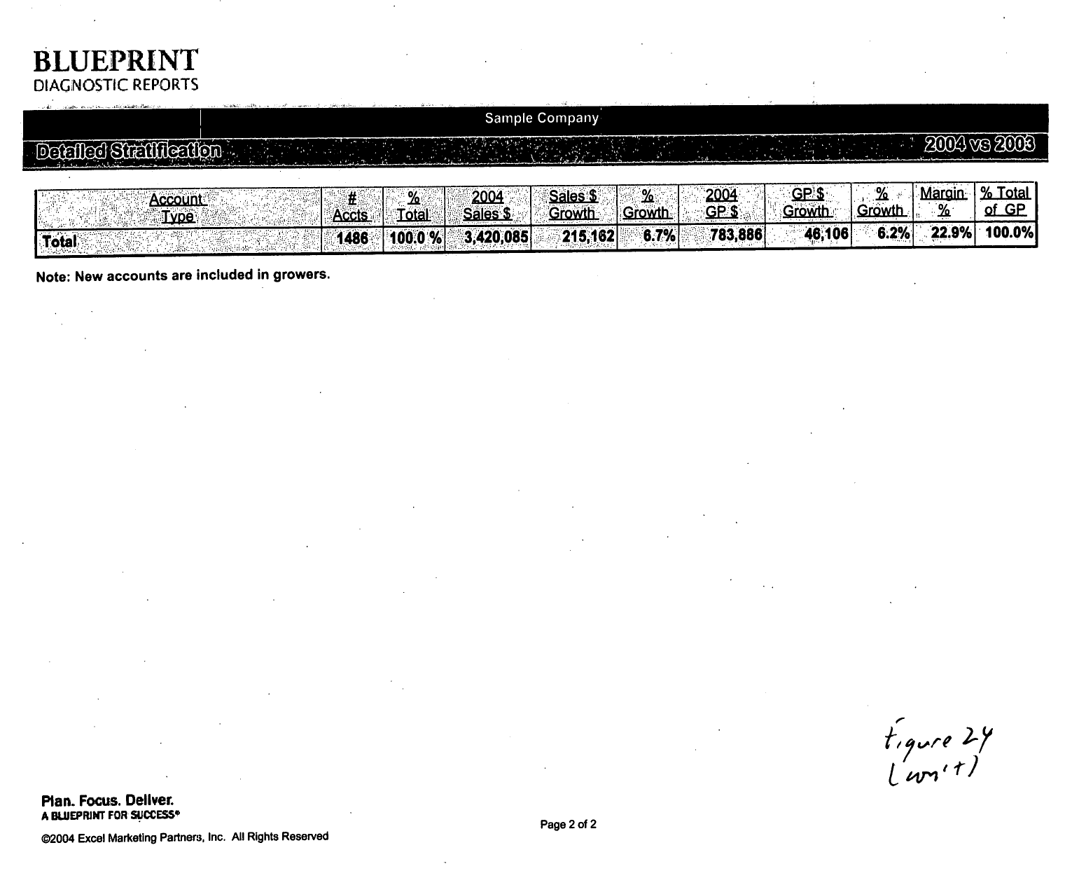

Referring to FIG. 2, a login screen in accordance with the principles of the present invention is seen. To enter the secure website, an e-mail identifier and a password is required. The client is provided with a password that is needed in order to access the secure website. Upon entering an e-mail identifier and valid password, the client enters the secure website. While as used herein, the user of the system in accordance with the principles of the present invention is referred to as the “client” and the entities on which analysis is conducted are referred to as the “customers”, these terms should not be interpreted in any way as limiting.

Referring to FIG. 3, a homepage screen in accordance with the principles of the present invention is seen. The homepage screen includes a user profile link, a reports link, a data management link, and an administration link, all described in detail below. In addition, a help link, a feedback link, and a logout link can be provided.

Referring to FIG. 4, a user profile screen in accordance with the principles of the present invention is seen. Profile information, which can be automatically filled in by the system can include the e-mail address identifier of the user, the name of the user, the name of the client, the business address of the client, the phone number of the user, and the job title of the user. A profile update option is provided as well as a change password option.

Referring to FIG. 5, a reports screen in accordance with the principles of the present invention is seen. Reports in accordance with the principles of the present invention are created from individual customer data and are provided to the appropriate level of management for quick analysis. In one embodiment, three levels of management are provided: administrators, managers, and sales representatives. For example, administrators have the authorization to set the company's options and download data as described in detail below, managers can view all reports described in detail below, and sales representatives can view their region and individual territory reports described in detail below. In other embodiments, other levels of management can be provided having different levels of security.

The reports can be customized to compare specific time periods and the data can be sorted on either sales or gross profit basis. Since the data is sorted and summarized for each report, the detailed account information can also be downloaded to a spreadsheet for a detailed customer review. In one embodiment, three categories of reports can be provided: customer analysis reports; segmentation analysis reports; and individual representative reports. Customer analysis reports can include customer stratification reports, customer growth and decline reports, and detailed stratification reports. Segmentation analysis reports can include industry segmentation reports, region summary reports, and sales representative/territory summary reports. Individual representative reports include sales representative/territory reports. These reports are described in more detail with respect to FIGS. 9-36, below.

Referring to FIG. 6, a data management screen in accordance with the principles of the present invention is seen. Data management allows administrators to manage the financial data of the client. Administrators can add data using an “Upload Data” functionality. Referring to FIG. 7, an upload data screen in accordance with the principles of the present invention is seen. The present invention allows for clients to upload data using the client's spreadsheet. To effectuate this data transfer, the spreadsheet is put into a standardized format under a standardized name. To upload data, a “Browse . . . ” button is chosen and the spreadsheet file is located on the client's computer. If the new data is to overwrite the existing data, the “Overwrite Data” radio button is chosen. If existing data is to be removed before the new data is inserted, the “Clear Data” radio button is chosen.

Referring back to the data management screen of FIG. 6, in one embodiment three links are provided to view, edit or delete data: financial breakdown; financial totals; and data summary. The financial breakdown displays the financial total per time period, for example monthly, of the data uploaded. This information is used to ensure the integrity of the reports. The financial totals represent the total sales and gross profits for a client. The data summary report shows the distinct rows of data under each column. This data can be used to locate bad or duplicate data and summarize sales data of the client.

Referring to FIG. 8, an administration screen in accordance with the principles of the present invention is seen. The administration screen allows client administrators to view and manage various aspects of the system of the present invention. By selecting the “User Management” button the administrator can view, add, modify or delete users. In addition, by selecting the “Company Management” button the administrator can customize the system by incorporating a company logo and selecting naming conventions for the locations of the client.

Referring back to FIG. 5, the customer stratification reports, customer growth and decline reports, and detailed stratification reports will be reviewed in detail. Customer stratification reports sort and rank a customer's purchase history by sales or gross profit from for example largest to smallest. To select a customer stratification report, the client clicks the corresponding radio button. The client is then linked to the customer stratification report screen seen in FIG. 9. The client chooses what level the report will address. This can be done at the company, branch, territory or representative level.

By selecting one of the company, branch, territory or representative levels, the client is linked to the customer stratification report summary page seen in FIG. 10. The client can customize categories or levels of profit contribution from its customers. Referring to FIG. 11, the client can choose the time period by year, quarter, month or can customize a time period. In an additional embodiment, the client can choose to have the report compare financial information by billing day instead of in total. To select the time period, the client chooses the time range to be compared by clicking on the radio button, using the up and down arrows to select by highlighting a time period within the range, and clicking “Back to Report Summary” to continue customizing the report.

In one embodiment, what customers are in each level are determined each time a report is run. In an additional embodiment, the client can choose to fix the customers that are in each level in order to monitor how that level of customers is doing. In an additional embodiment, the client can choose to have the system determine what customers are in each level automatically based on a chosen time frame.

Referring to FIG. 12, the client can customize the criteria for each category by inputting a dollar amount. Referring to FIG. 13, the client can select which key financial indicator to emphasize for the analysis. By selecting sales, the report will be sorted on the “Sales Dollar” column; by selecting gross profit, the report will be sorted on the “Gross Profit Dollar” column.

Referring to FIG. 14, the client can choose the level of detail for the report. To select the data for a company, a company name is selected from the list. Multiple companies can be selected by pressing the “Shift” button on a keyboard and clicking on the names of the companies. To further filter data for a company using the second level of the organization structure of the company, the name of the branch is selected from list. To further filter data for a company using the third level of the organization structure of the company, the name of the territory is selected from list. To further filter data for a company using the name of a manager, the name of the manager is selected from list. To further filter data for a company using the name of a representative, the name of the representative is selected from list. Multiple representatives can be selected by pressing the “Shift” button on a keyboard and clicking on the names of the representatives.

Referring to FIG. 15, the client can choose the sort column for data among sales, sales growth, gross profit or gross profit growth. Following this and each such step described above, the client can return to the customer stratification report summary page seen in FIG. 10 by clicking the “Back to Report Summary” to continue customizing the report.

An example of a customer stratification report is set forth in FIG. 16. Along one side, here the vertical the customized categories or levels of profit contribution from customers are set forth. In this example, six categories are provided, with category “A” having greater than $2,000 in gross profit, category “B” having greater than $1,000 in gross profit, category “C” having greater than $500 in gross profit, category “D” having less than $500 in gross profit, a lost or zero margin category, and a negative margin category.

Along the other side, here the horizontal the following columns are provided: “# [Number] of Accounts”; “/o [Percent] Total”; “2004 Sales $ [Dollars]”; “Sales $ [Dollar] Growth”; “% [Percent] Growth”; “2004 GP [Gross Profit] $ [Dollars]”; “GP [Gross Profit] $ [Dollar] Growth”; “% [Percent] Growth”; “Margin % [Percent]”; and “% [Percent] Total of GP [Gross Profit]”. Totals for each column are provided.

Thus, the customer stratification report can provide a client with the ability to analyze its overall business and profitability. In addition, the customer stratification report can highlight various statistics about the categories or levels of profit contribution, such as in this example that the 366 top accounts in categories “A”, “B”, and “C” represent 24.6% of all accounts, 82.9% of total sales, and 85.6% of total gross profit.

Referring back to FIG. 5, customer growth and decline reports provide an insight into growing or declining customers. To select a customer growth and decline report, the client clicks the corresponding radio button. The client is then linked to the customer growth and decline report screen seen in FIG. 17. The client chooses what level the report will address. This can be done at the company, branch, territory or representative level. By selecting one of the company, branch, territory or representative levels, the client is linked to the customer growth and decline report summary page seen in FIG. 18. As with the customer stratification reports, the client can choose the time period as in FIG. 11, the client can select which key financial indicator to emphasize for the analysis as in FIG. 13, the client can choose the level of detail for the report as in FIG. 14, and the client can choose the sort column for data as in FIG. 15.

In addition, in the customer growth and decline reports the client can customize the criteria for stable customers. Referring to FIG. 19, the client can customize the criteria for stable customers by inputting a percentage range that defines an acceptable amount of growth and decline. Again, following this and each such step described above the client can return to the customer growth and decline report summary page seen in FIG. 18 by clicking the “Back to Report Summary” to continue customizing the report.

An example of a customer growth and decline report is set forth in FIG. 20. Along one side, here the vertical the customer growth and decline categories are set forth. In this example, six categories are provided: “New Accounts”; “Growers”; “Stable”; “Decliners”; “Lost or Zero Margin”; and “Negative Margin”. Again, along the other side, here the horizontal the following columns are provided: “# [Number] of Accounts”; “% [Percent] Total”; “2004 Sales $ [Dollars]”; “Sales $ [Dollar] Growth”; “% [Percent] Growth”; “2004 GP [Gross Profit] $ [Dollars]”; “GP [Gross Profit] $ [Dollar] Growth”; “% [Percent] Growth”; “Margin % [Percent]”; and “% [Percent] Total of GP [Gross Profit]”. Totals for each column are provided.

Thus, the customer growth and decline report provides the client with an understanding the growth/decline patterns of each customer and allows the client to take action on these important early warning signs. For example, the customer growth and decline report provides the client with the opportunity to easily identify those customers where sales or gross profit might indicate a decline in business. In addition, the customer growth and decline report can highlight various statistics about the growers and decliners. In this example, growing customers account for 80.7% of all accounts, 11.7% of sales growth, 11.7% of gross profit growth, and 82.3% of gross profit while declining customers account for 1.8% of all accounts, 17.1% of sales decline, 16.9% of gross profit decline, and 2.2% of gross profit. In addition, the Customer Growth and Decline report can provide statistics such as sales per customer growth or decline for the growers and decliners. Still further, the Customer Growth and Decline report can offer recommended nutshell observations such as in this example:
“Reducing GP [Gross Profit] loss in declining accounts by one-half to 3.3% would generate an additional $5,488 and would gave allowed Gross Profit to finish the period with an increase of $51,594.”

Referring back to FIG. 5, detailed stratification reports provide an overview of a customer's growth and decline within the categories defined in the stratification report. To select a detailed stratification report, the client clicks the corresponding radio button. The client is then linked to the detailed stratification report screen seen in FIG. 21. The client chooses what level the report will address. This can be done at the company, branch, territory or representative level. By selecting one of the company, branch, territory or representative levels, the client is linked to the detailed stratification report summary page seen in FIG. 22. As with the customer stratification reports, the client can choose the time period as in FIG. 11, the client can select which key financial indicator to emphasize for the analysis as in FIG. 13, the client can choose the level of detail for the report as in FIG. 14, and the client can choose the sort column for data as in FIG. 15.

Referring to FIG. 23, the client can customize both the criteria for each category by inputting a dollar amount and the criteria for stable customers by inputting a percentage range that defines an acceptable amount of growth and decline. Following this and each such step described above, the client can return to the detailed stratification report summary page seen in FIG. 22 by clicking the “Back to Report Summary” to continue customizing the report.

An example of a detailed stratification report is set forth in FIG. 24. Detailed Stratification reports further detail the customized categories or levels of profit contribution from customers in the customer stratification report. Thus, continuing the example, six categories again are provided, with category “A” having greater than $2,000 in gross profit, category “B” having greater than $1,000 in gross profit, category “C” having greater than $500 in gross profit, category “D” having less than $500 in gross profit, a lost or zero margin category, and a negative margin category. For categories “A”, “B”, and “C”, additional stratification is provided as “Growers”; “Stable”; and “Decliners”.

Again, along the other side, here the horizontal the following columns are provided: “# [Number] of Accounts”; “% [Percent] Total”; “2004 Sales $ [Dollars]”; “Sales $ [Dollar] Growth”; “/o [Percent] Growth”; “2004 GP [Gross Profit] $ [Dollars]”; “GP [Gross Profit] $ [Dollar] Growth”; “% [Percent] Growth”; “Margin % [Percent]”; and “% [Percent] Total of GP [Gross Profit]”. Totals for each column are provided. Thus, the detailed stratification report helps clients understand the churn within different customer categories.

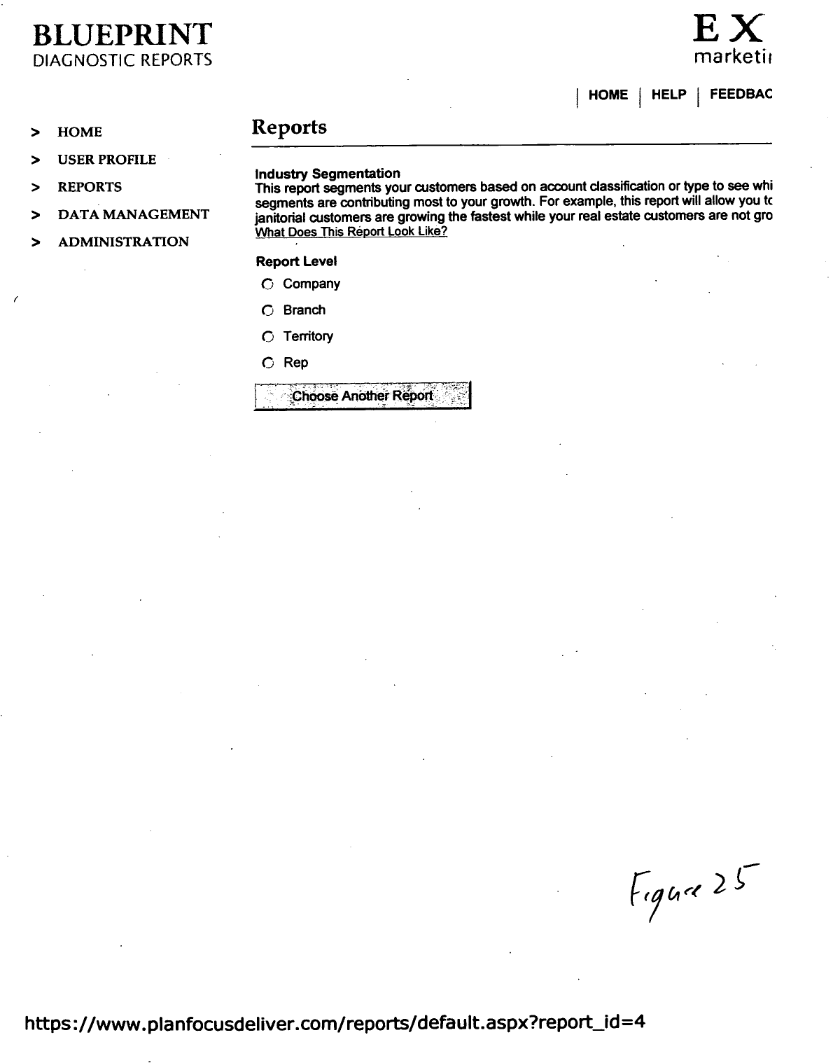

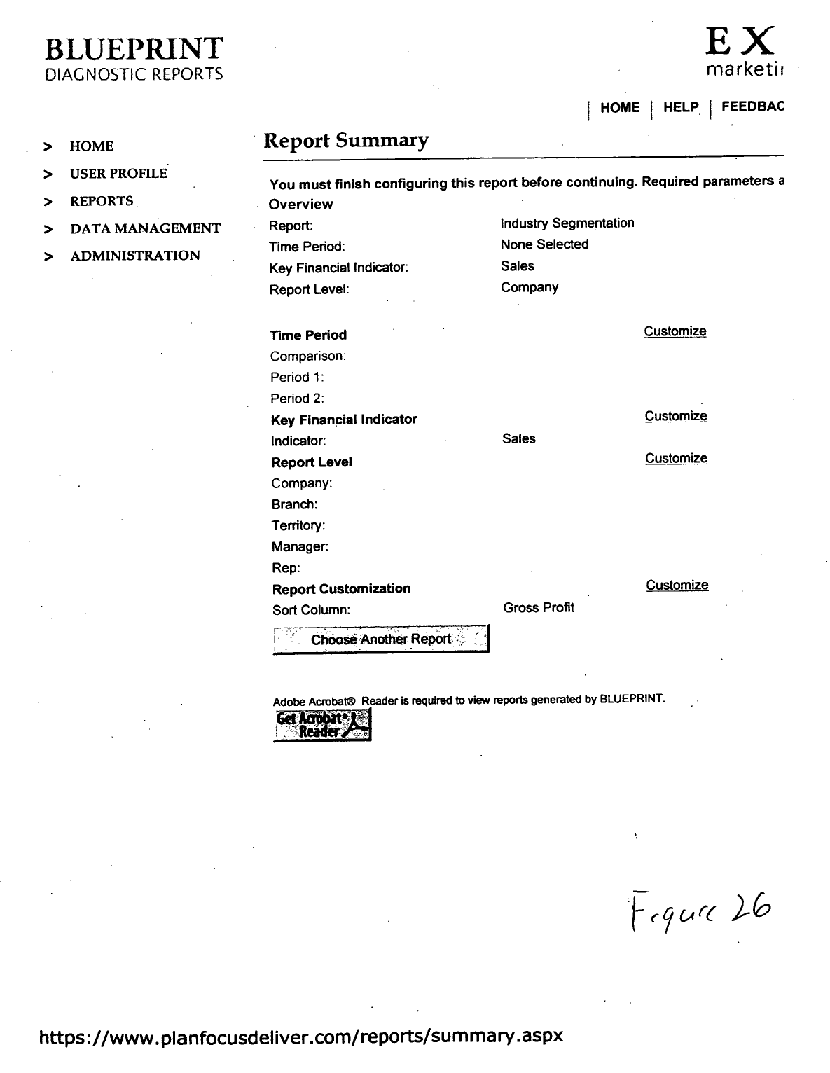

Referring back to FIG. 5, industry segmentation reports segment customers based on account classification or type to expose which industry segments are contributing most to growth. To select an industry segmentation report, the client clicks the corresponding radio button. The client is then linked to the industry segmentation report screen seen in FIG. 25. The client chooses what level the report will address. This can be done at the company, branch, territory or representative level. By selecting one of the company, branch, territory or representative levels, the client is linked to the industry segmentation report summary page seen in FIG. 26. As with the customer stratification reports, the client can choose the time period as in FIG. 11, the client can select which key financial indicator to emphasize for the analysis as in FIG. 13, the client can choose the level of detail for the report as in FIG. 14, and the client can choose the sort column for data as in FIG. 15. Following each such step described above, the client can return to the industry segmentation report summary page seen in FIG. 26 by clicking the “Back to Report Summary” to continue customizing the report.

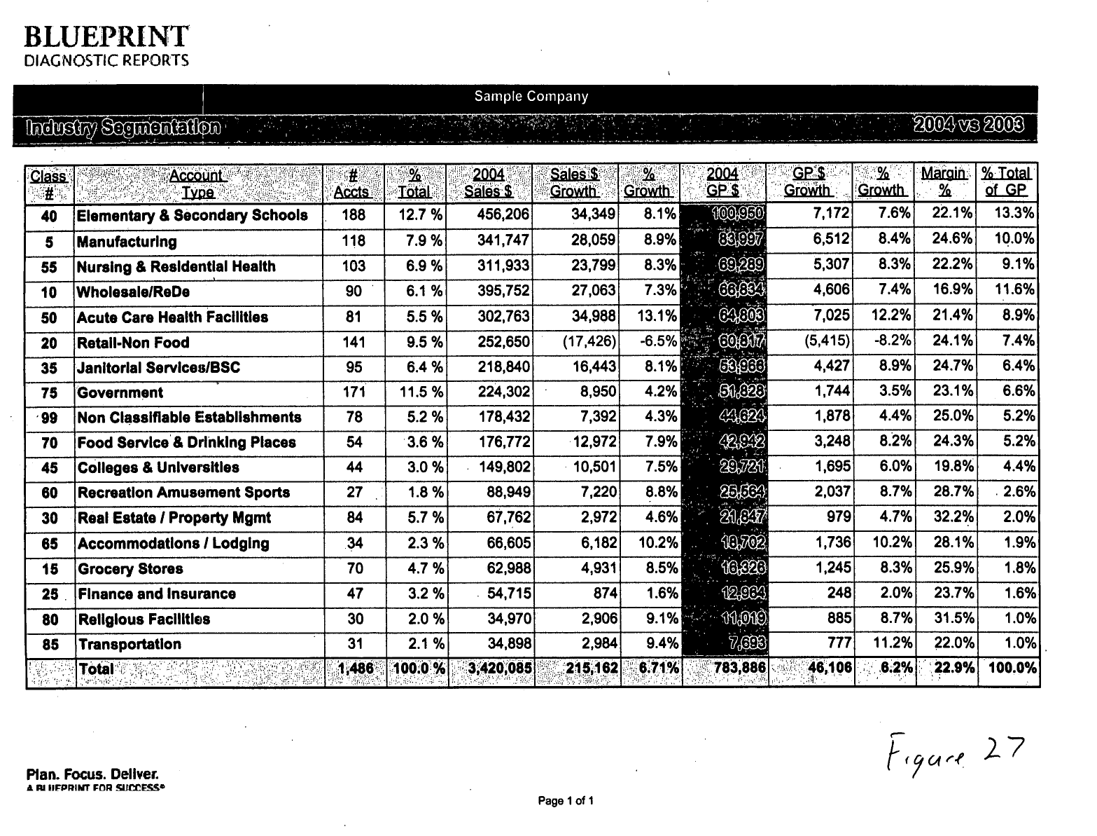

An example of an industry segmentation report is set forth in FIG. 27. Along one side, here the vertical the customers are categorized into different industry types. Again, along the other side, here the horizontal the following columns are provided: “# [Number] of Accounts”; “% [Percent] Total”; “2004 Sales $ [Dollars]”; “Sales $ [Dollar] Growth”; “% [Percent] Growth”; “2004 GP [Gross Profit] $ [Dollars]”; “GP [Gross Profit] $ [Dollar] Growth”; “% [Percent] Growth”; “Margin % [Percent]”; and “% [Percent] Total of GP [Gross Profit]”. Totals for each column are provided. Thus, in this example the industry segmentation reports allows clients to see trends such as for example that janitorial customers are growing the fastest while real estate customers are not growing at all.

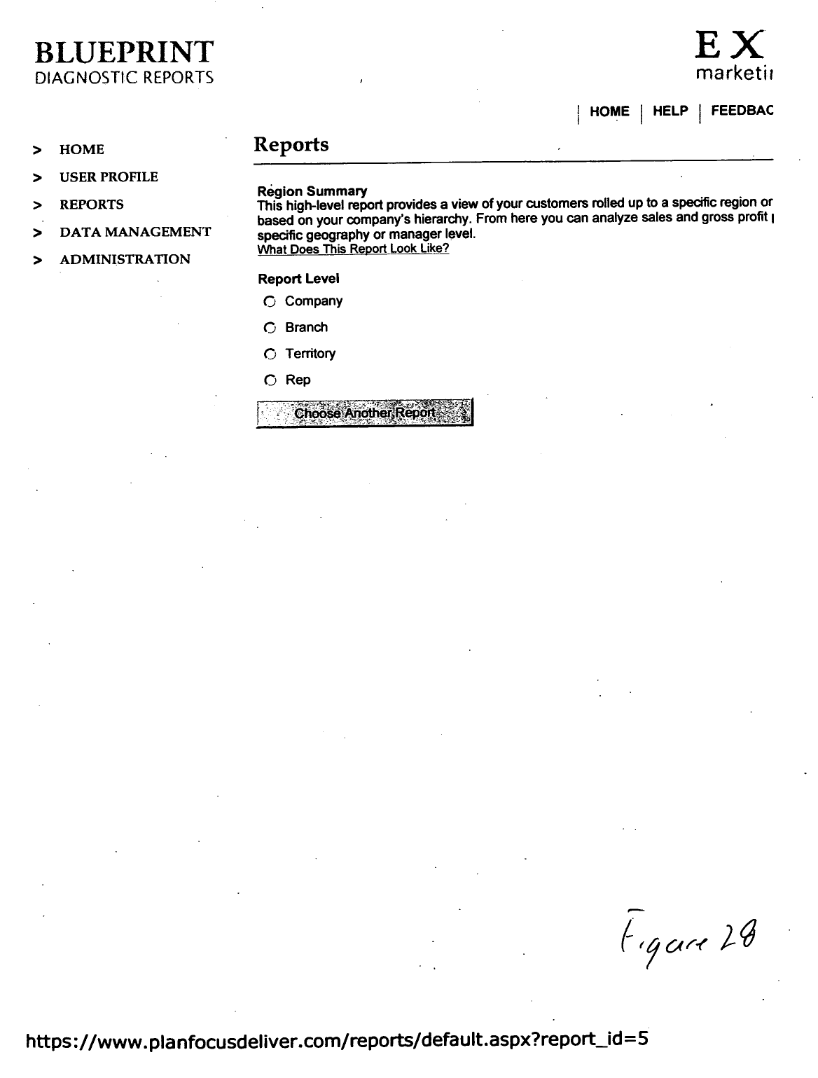

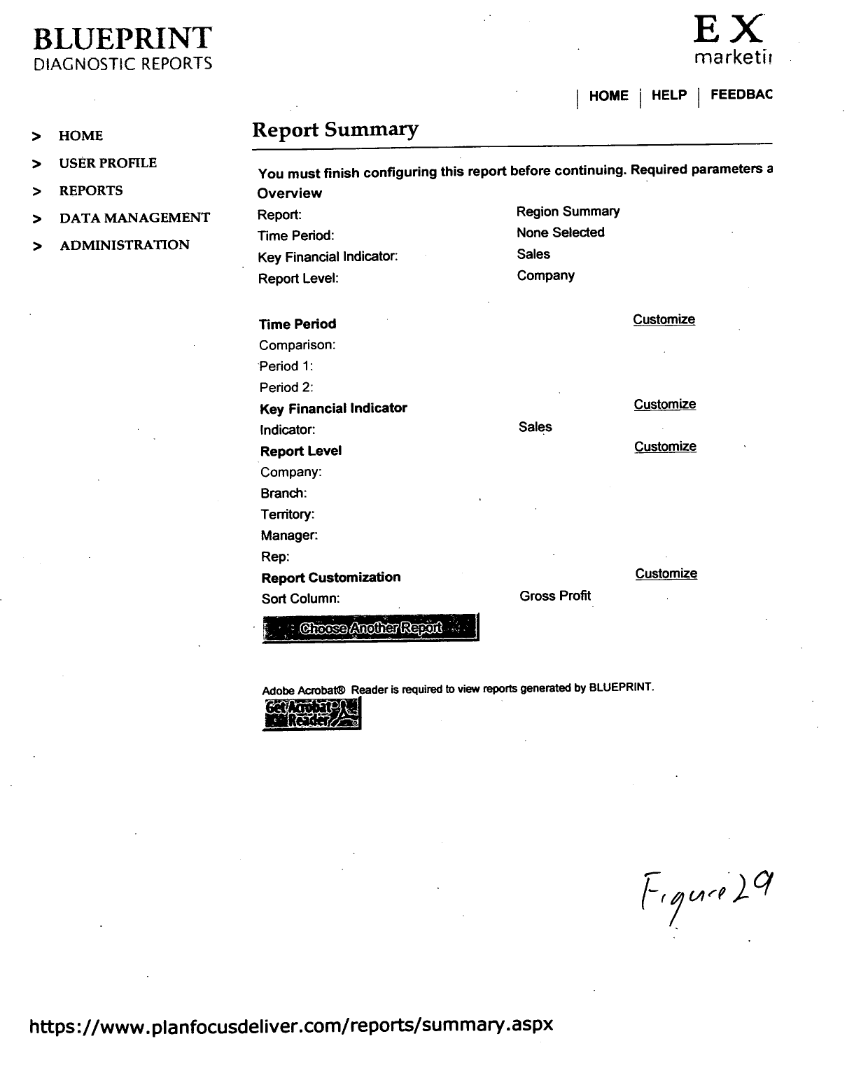

Referring back to FIG. 5, region summary reports provide a view of customers relative to a specific region or area of the country. To select a region summary report, the client clicks the corresponding radio button. The client is then linked to the region summary report screen seen in FIG. 28. The client chooses what level the report will address. This can be done at the company, branch, territory or representative level. By selecting one of the company, branch, territory or representative levels, the client is linked to the industry segmentation report summary page seen in FIG. 29. As with the customer stratification reports, the client can choose the time period as in FIG. 11, the client can select which key financial indicator to emphasize for the analysis as in FIG. 13, the client can choose the level of detail for the report as in FIG. 14, and the client can choose the sort column for data as in FIG. 15. Following each such step described above, the client can return to the industry segmentation report summary page seen in FIG. 29 by clicking the “Back to Report Summary” to continue customizing the report.

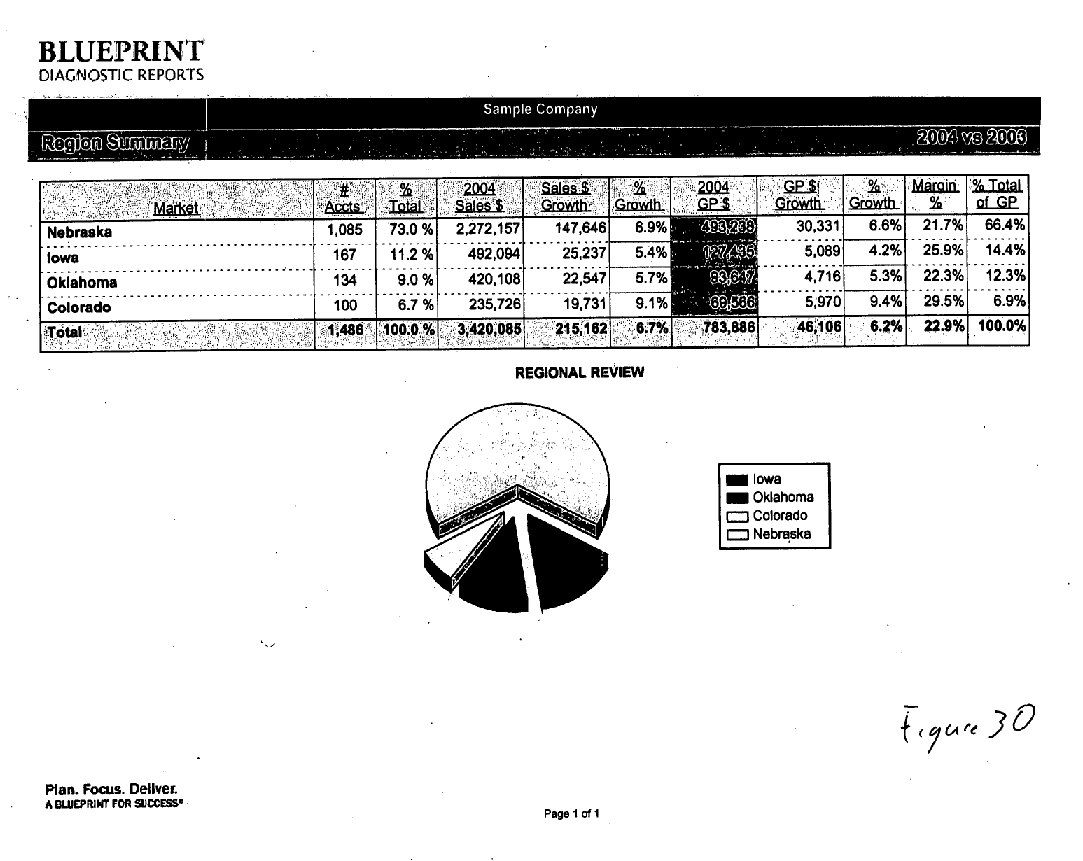

An example of a region summary report is set forth in FIG. 30. Along one side, here the vertical the customers are categorized into different geographic areas. Again, along the other side, here the horizontal the following columns are provided: “# [Number] of Accounts”; “% [Percent] Total”; “2004 Sales $ [Dollars]”; “Sales $ [Dollar] Growth”; “% [Percent] Growth”; “2004 GP [Gross Profit] $ [Dollars]”; “GP [Gross Profit] $ [Dollar] Growth”; “% [Percent] Growth”; “Margin % [Percent]”; and “% [Percent] Total of GP [Gross Profit]”. Totals for each column are provided. Thus, the region summary report allows clients to analyze sales and gross profit performance by a specific geography or manager level. In addition, the region summary report can provide a graphical representation of the different geographic areas such as for example the pie chart in FIG. 13.

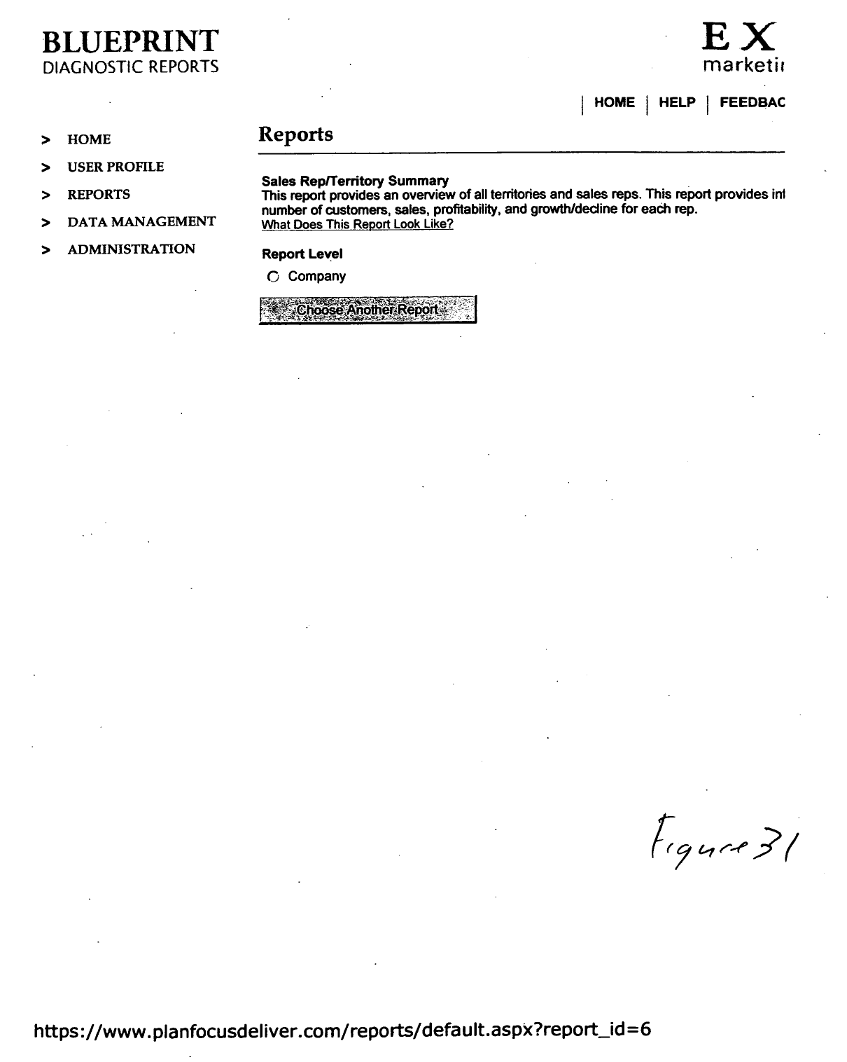

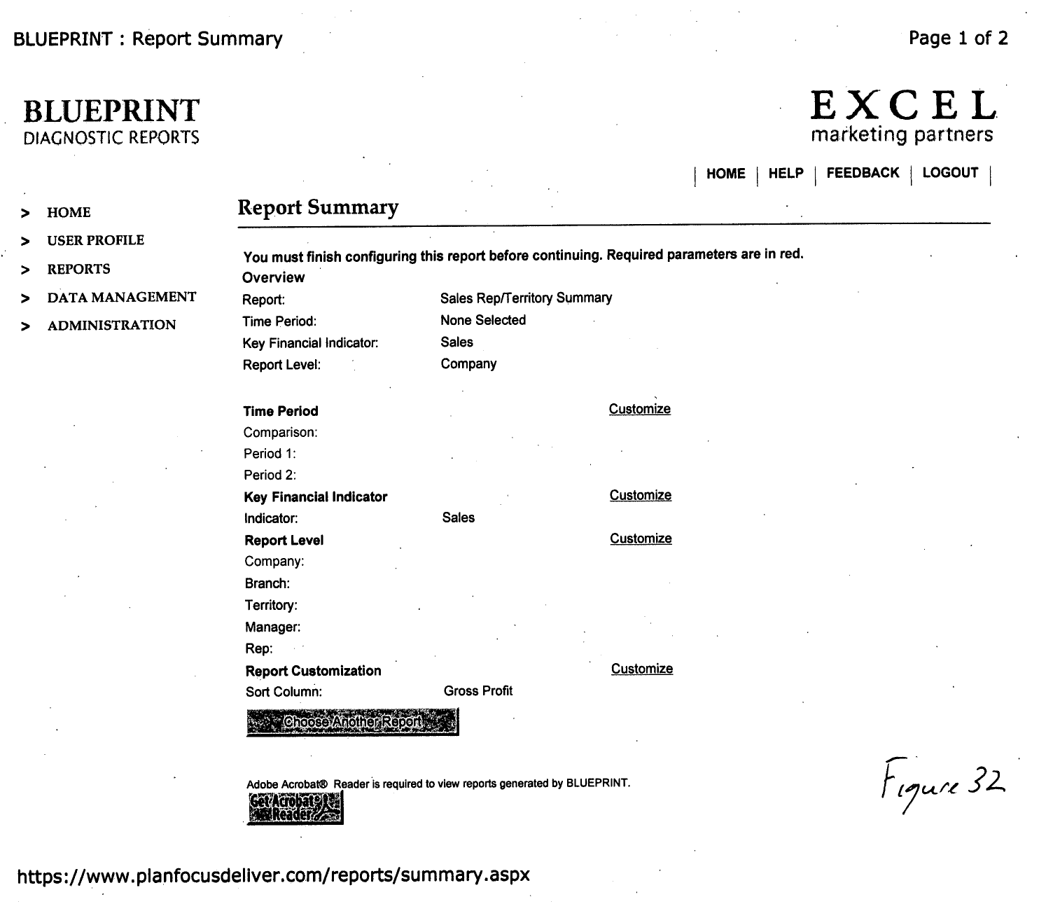

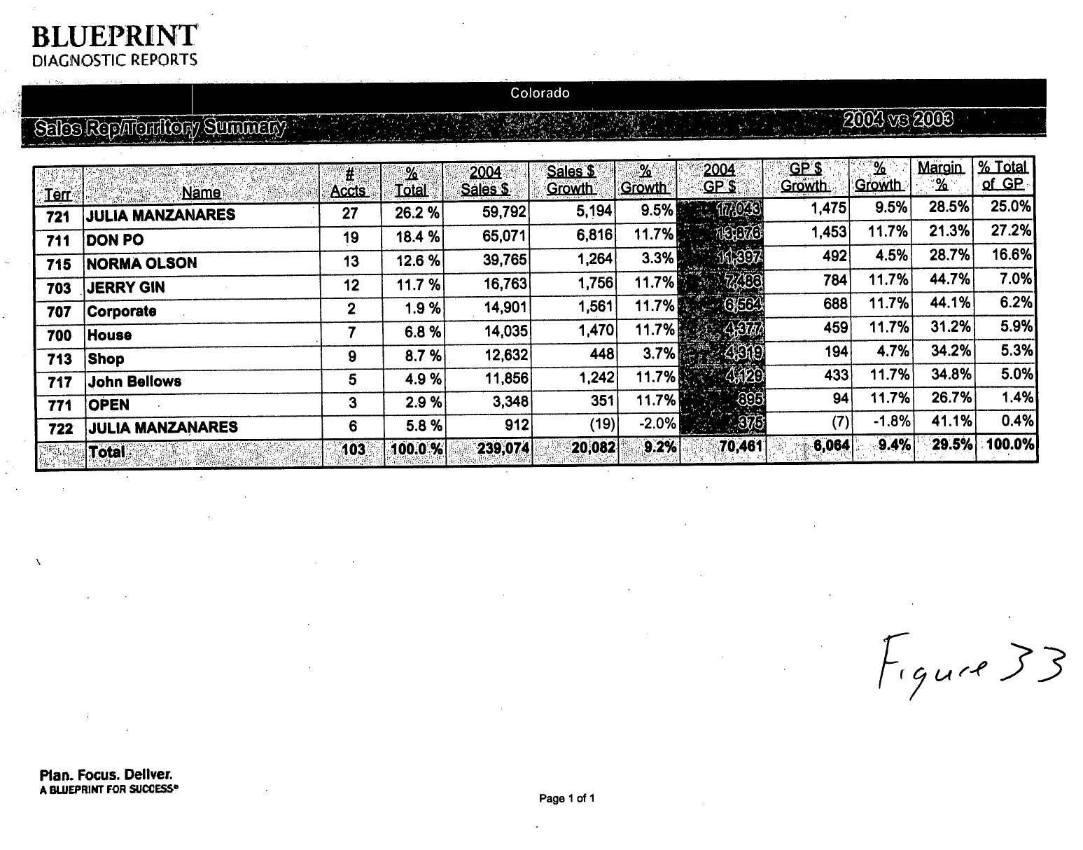

Referring back to FIG. 5, sales representative/territory summary reports provide an overview of territories and sales representatives at the company level. To select a sales representative/territory summary report, the client clicks the corresponding radio button. The client is then linked to the sales representative/territory summary report screen seen in FIG. 31. Sales representative/territory summary reports at the company level. By selecting the company level, the client is linked to the industry segmentation report summary page seen in FIG. 32. As with the customer stratification reports, the client can choose the time period as in FIG. 11, the client can select which key financial indicator to emphasize for the analysis as in FIG. 13, the client can choose the level of detail for the report as in FIG. 14, and the client can choose the sort column for data as in FIG. 15. Following each such step described above, the client can return to the industry segmentation report summary page seen in FIG. 32 by clicking the “Back to Report Summary” to continue customizing the report.

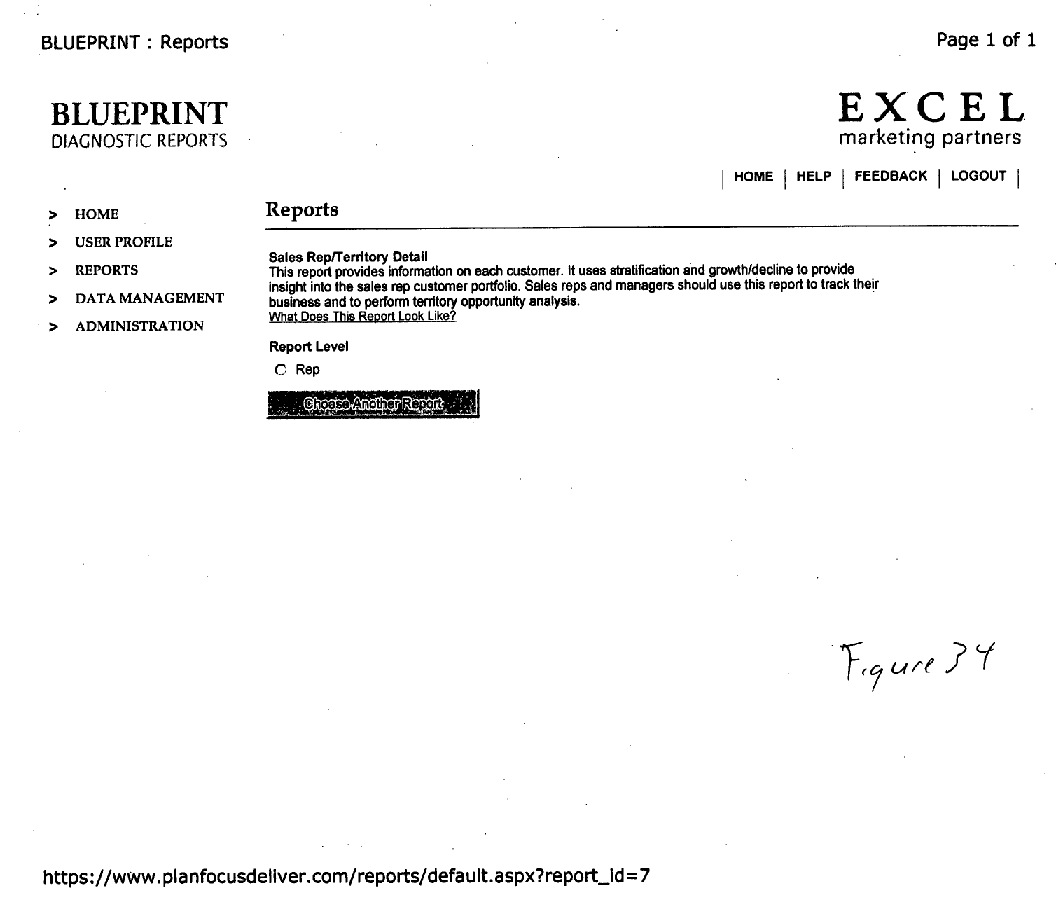

An example of a sales representative/territory summary report is set forth in FIG. 33. Along one side, here the vertical the sales representatives are listed. Again, along the other side, here the horizontal the following columns are provided: “# [Number] of Accounts”; “% [Percent] Total”; “2004 Sales $ [Dollars]”; “Sales $ [Dollar] Growth”; “% [Percent] Growth”; “2004 GP [Gross Profit] $ [Dollars]”; “GP [Gross Profit] $ [Dollar] Growth”; “% [Percent] Growth”; “Margin % [Percent]”; and “% [Percent] Total of GP [Gross Profit]”. Totals for each column are provided. Thus, the sales representative/territory summary report provides information such as number of customers, sales, profitability, and growth/decline for each representative.

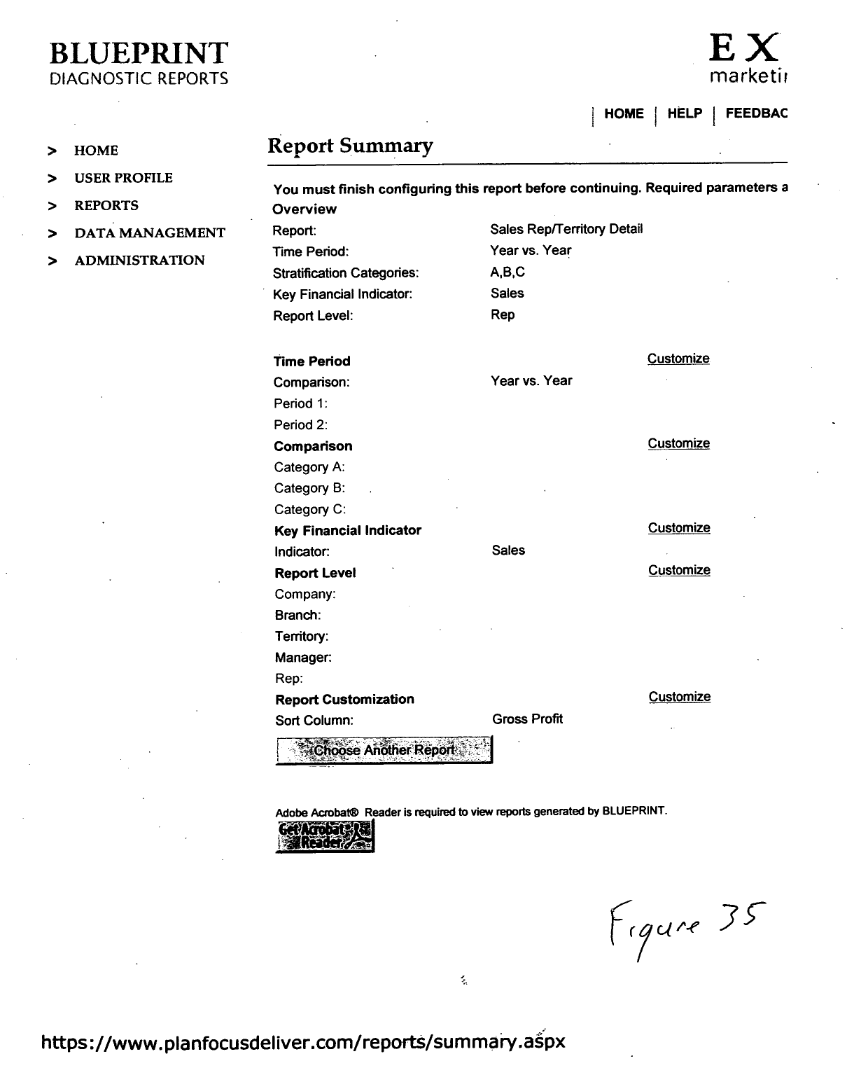

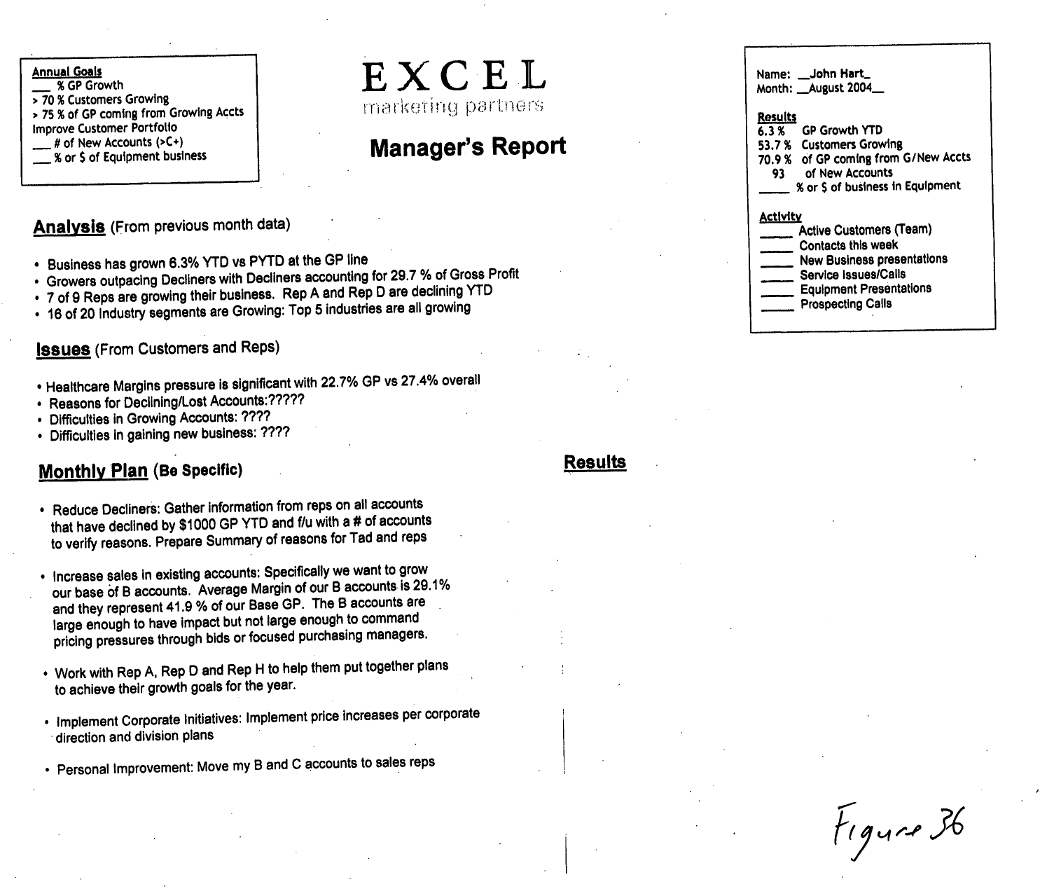

Referring back to FIG. 5, sales representative/territory detail reports provide information on each customer at the representative level. To select a sales representative/territory detail report, the client clicks the corresponding radio button. The client is then linked to the sales representative/territory detail summary report screen seen in FIG. 34. Sales representative/territory detail reports at the representative level. By selecting the representative level, the client is linked to the industry segmentation report summary page seen in FIG. 35. As with the customer stratification reports, the client can choose the time period as in FIG. 11, the client can customize the criteria for each category by inputting a dollar amount as in FIG. 12, the client can select which key financial indicator to emphasize for the analysis as in FIG. 13, the client can choose the level of detail for the report as in FIG. 14, and the client can choose the sort column for data as in FIG. 15. Following each such step described above, the client can return to the industry segmentation report summary page seen in FIG. 35 by clicking the “Back to Report Summary” to continue customizing the report.

The sales representative/territory detail report is provided as a spreadsheet so customer can massage information/flexibility Thus, the sales representative and managers can use the sales representative/territory detail report to track their business and to perform territory opportunity analysis. The sales representative/territory detail report provides the sales representative with a template to estimate potential opportunity and plan for future sales and gross profit growth.

In each of the customer analysis or segmentation analysis reports, a “Data Detail” tab is provided on the top navigation bar. To see individual customer information, a manager can click on the “Data Detail” tab. The “Data Detail” tab also allows the client to export and save a file into spreadsheet where further manipulation of the information can occur. This can provides an in-depth view of account level detail by allowing the client to further manipulate columns and rows of data based on client preference.

In an additional embodiment, the sales diagnostic system of the present invention can be utilized to create sales planning reports. In one embodiment, these sales planning reports can comprise a high level sales vice president's report, a sales manager's report, a sales representative's monthly plan report, and a sales representative's weekly activity report. In a further embodiment, once these sales planning reports have been created the client can choose to have the actual sales run as a comparison to the planned sales.

Referring to FIG. 36, a manager's report is seen. The manager's report includes an analysis section, an issues section, a monthly plan section, and a results section. In one embodiment, the analysis section provides a snapshot of the previous month's data. In one embodiment, the issues section provides a snap shot of the customer's issues for the sales representative to address. The monthly plan section sets forth specific action items for the sales representative. The manager's report can also include an annual goals summary section that reminds the manager of the annual goals and a sales representative's summary section that provides the manager with the particular sales representative's performance. Data for several of these columns such as the issues section can be provided in draft automatically from the data contained in the sales diagnostic system of the present invention.

Referring to FIG. 37, a sales representative's monthly plan report is seen. Again, the sales representative's monthly plan report can include an annual goals summary section that reminds the sales representative of the annual goals and a sales representative's summary section that provides the sales representative with the particular sales representative's performance. The sales representative's monthly plan report includes a plan column, an account type column, and an issues/results column. The accounts are segmented into declining accounts, growth accounts, and new accounts. The particular information for these segments can be provided in draft automatically from the data contained in the sales diagnostic system of the present invention. The sales representative's monthly plan report can further include a portfolio imitative section that sets a goal on what the sales representative's customer portfolio should look like in the future, a corporate initiatives section that sets forth field programs to meet corporate initiatives, a personal development section that outlines areas to develop to improve the sales representative's performance, and a monthly summary/overview.

Referring to FIG. 38, a sales representative's weekly activity report is seen. The sales representative's weekly activity report can include a monthly activity standards section and a sales representative's weekly summary section. The sales representative's weekly activity report includes an account column that is segmented into an active account base and a prospecting base; a type of account column, a date column, a contact column, a progress/update column, and a next steps column. Again, data for several of these columns such as the account column can be provided in draft automatically from the data contained in the sales diagnostic system of the present invention.

While the invention has been described with specific embodiments, other alternatives, modifications and variations will be apparent to those skilled in the art. Accordingly, it will be intended to include all such alternatives, modifications and variations set forth within the spirit and scope of the appended claims.

What is claimed is:

1. An automated system for analyzing customer trends comprising:
uploading customer data;
sorting by categories of customer sales characteristics; and
displaying a quantity of accounts for categories of customer sales characteristics, a quantification of categories of customer sales characteristics, and the contribution of the categories of customer sales characteristics.

2. The automated system of claim 1 further wherein the step of sorting by customer sales characteristics comprises sorting by sales growers and decliners.

3. The automated system of claim 1 further including highlighting various statistics about the categories of customer characteristics.

4. The automated system of claim 3 further wherein the step of highlighting various statistics about the categories of customer characteristics is selected from the group comprising highlighting various statistics about customer growers and decliners offering recommended nutshell observations, and combinations thereof.

5. The automated system of claim 1 further including providing access to further detail on the categories of customer characteristics.

6. The automated system of claim 1 further wherein the step of displaying a quantity of accounts for categories of customer sales characteristics is selected from the group comprising displaying number of accounts; displaying percentage of total; displaying sales, sales growth, and percentage of sales growth; displaying gross profit, gross profit growth, and percentage of gross profit growth; displaying a percentage of total of gross profit; displaying margin percentage; and combinations thereof.

7. The automated system of claim 1 further comprising allowing the clients to chooses what level the report will address.

8. The automated system of claim 1 further comprising allowing the client to customize categories or levels of profit contribution from its customers.

9. The automated system of claim 1 further comprising customizing the reports to compare specific time periods.

10. The automated system of claim 1 further comprising downloading detailed account information to a spreadsheet.

11. The automated system of claim 1 further comprising creating customer analysis reports.

12. The automated system of claim 11 further comprising creating reports from the group comprising customer stratification reports, customer growth and decline reports, detailed stratification reports, and combinations thereof.

13. The automated system of claim 1 further comprising creating segmentation analysis reports.

14. The automated system of claim 13 further comprising creating reports from the group comprising industry segmentation reports, region summary reports, sales representative/territory summary reports, and combinations thereof.

15. The automated system of claim 1 further comprising creating individual representative reports.

16. The automated system of claim 15 further comprising creating sales representative/territory reports.

17. The automated system of claim 15 further comprising displaying the financial total per time period of the data uploaded.

18. The automated system of claim 15 further comprising displaying the total sales and gross profits for a client.

19. The automated system of claim 1 further comprising designating stable customers.

20. The automated system of claim 19 further comprising allowing the client to customize the criteria for stable customers.

21. The automated system of claim 20 further comprising customizing the criteria for stable customers by inputting a percentage range that defines an acceptable amount of growth and decline

22. An automated system for analyzing customer trends comprising:
uploading customer data;
creating reports in accordance with individual customer data;
providing reports to the appropriate level of management for quick analysis; and
utilizing data from the reports to create sales planning reports.

23. The automated system of claim 22 further wherein the step of utilizing data from the reports to create sales planning reports is selected from the group comprising utilizing data from the reports to create a high level sales vice president's report; utilizing data from the reports to create a sales manager's report; utilizing data from the reports to create a sales representative's monthly plan report, and a sales representative's weekly activity report; and combinations thereof.

24. The automated system of claim 22 further comprising allowing the clients to choose what level the report will address.

25. The automated system of claim 22 further comprising customizing the reports to compare specific time periods.

26. The automated system of claim 22 further comprising customizing the reports to compare specific time periods.

27. The automated system of claim 22 further comprising downloading detailed account information to a spreadsheet.

28. The automated system of claim 22 further comprising creating customer analysis reports.

29. The automated system of claim 22 further comprising creating segmentation analysis reports.

30. The automated system of claim 22 further comprising creating individual representative reports.

31. An automated system for analyzing customer trends comprising:
uploading customer data;
sorting by categories of customer sales characteristics;
creating standardized reports in accordance with the customer data; and
highlighting various statistics about the categories of customer characteristics.

32. The automated system of claim 31 further wherein the step of highlighting various statistics about the categories of customer characteristics is selected from the group comprising highlighting various statistics about customer growers and decliners; offering recommended nutshell observations; and combinations thereof.

33. The automated system of claim 31 further wherein the step of sorting by customer sales characteristics comprises sorting by sales growers and decliners.

34. The automated system of claim 31 further including displaying a quantity of accounts for categories of customer sales characteristics, a quantification of categories of customer sales characteristics, and the contribution of the categories of customer sales characteristics.

35. The automated system of claim 34 further wherein the step of displaying a quantity of accounts for categories of customer sales characteristics is selected from the group comprising displaying number of accounts; displaying percentage of total; displaying sales, sales growth, and percentage of sales growth; displaying gross profit, gross profit growth, and percentage of gross profit growth; displaying a percentage of total of gross profit; displaying margin percentage; and combinations thereof.

36. The automated system of claim 31 further including providing access to further detail on the categories of customer characteristics.

37. The automated system of claim 31 further comprising allowing the client to download the reports.

38. The automated system of claim 31 further comprising allowing the client to download detailed account information to a spreadsheet.

39. The automated system of claim 31 further comprising customizing the reports to compare specific time periods.

40. The automated system of claim 31 further comprising downloading detailed account information to a spreadsheet.

41. The automated system of claim 31 further comprising creating customer analysis reports.

42. The automated system of claim 41 further comprising creating reports from the group comprising customer stratification reports, customer growth and decline reports, detailed stratification reports, and combinations thereof.

43. The automated system of claim 31 further comprising creating segmentation analysis reports.

44. The automated system of claim 43 further comprising creating reports from the group comprising industry segmentation reports, region summary reports, sales representative/territory summary reports, and combinations thereof.

45. The automated system of claim 31 further comprising creating individual representative reports.

46. The automated system of claim 45 further comprising creating sales representative/territory reports.

47. The automated system of claim 45 further comprising displaying the financial total per time period of the data uploaded.

48. The automated system of claim 45 further comprising displaying the total sales and gross profits for a client.

49. The automated system of claim 31 further comprising designating stable customers.

50. The automated system of claim 49 further comprising allowing the client to customize the criteria for stable customers.

51. The automated system of claim 51 further comprising customizing the criteria for stable customers by inputting a percentage range that defines an acceptable amount of growth and decline

52. An automated system for analyzing customer trends comprising:
allowing for clients to upload data utilizing a client spreadsheet over a wide area network;
creating reports in accordance with individual customer data; and
providing access to the reports over the wide area network to the appropriate level of management for quick analysis.

53. The automated system of claim 52 further wherein the steps of allowing for clients to upload data over a wide area network and providing reports over the wide area network comprise allowing for clients to upload data over the Internet and providing reports over the Internet.

54. The automated system of claim 52 further wherein the step of providing reports to the appropriate level of management comprises providing different reports to administrators, managers, and sales representatives.

55. The automated system of claim 52 further comprising customizing the reports to compare specific time periods.

56. The automated system of claim 52 further comprising downloading detailed account information over the wide area network to a spreadsheet.

57. The automated system of claim 52 further comprising creating reports selected form the group comprising customer analysis reports, segmentation analysis reports, individual representative reports, and combinations thereof.

58. An automated system for analyzing customer trends comprising:
uploading customer data;
creating reports in accordance with individual customer data;
providing reports to the appropriate level of management for quick analysis; and
with the reports, providing a link from the summary data to detailed backup data sorted by customer sales characteristics.

59. The automated system of claim 58 further wherein the step of sorting by customer sales characteristics comprises sorting customers by account in order of significance consistent with the summary report.

60. The automated system of claim 58 further wherein the step of sorting by customer sales characteristics comprises sorting by sales growers and decliners.

61. The automated system of claim 58 further wherein the step of providing a link from the summary data to the detailed, backup data clicking on a “Data Detail” tab.

62. The automated system of claim 58 further wherein the step of providing reports to the appropriate level of management comprises providing different reports to administrators, managers, and sales representatives.

63. The automated system of claim 58 further comprising customizing the reports to compare specific time periods.

64. The automated system of claim 58 further comprising customizing the reports sort data.

65. The automated system of claim 58 further comprising downloading detailed account information to a spreadsheet.

66. The automated system of claim 58 further comprising creating reports selected form the group comprising customer analysis reports, segmentation analysis reports, individual representative reports, and combinations thereof.

67. The automated system of claim 58 further comprising sorting and ranking a customer's purchase history by sales or gross profit from largest to smallest.
